(19) United States
(12) Patent Application Publication
(10) Pub. No.: US 2026/0141324 A1
(43) Pub. Date: May 21, 2026

(54) Intelligent Linking of Submittal and Schedule Objects Within a Construction Management Software Application

(71) Applicant: Procore Technologies, Inc., Carpinteria, CA (US)

(72) Inventors: Shelley Prakash Duggal, Austin, TX (US); Matt Man, Thornhill (CA); Michael David Fairchild, Ventura, CA (US); Samuel Thomas Weston Butler, Austin, TX (US)

(21) Appl. No.: 18/952,908

(22) Filed: Nov. 19, 2024

(51) Int. Cl. G06Q 10/0631; G06Q 50/08

(52) U.S. Cl. CPC G06Q 10/06315; G06Q 10/06312; G06Q 50/08

(57) ABSTRACT

A computing platform is configured to (i) receive a request to identify schedule-item data objects within a construction management software application that are related to a submittal data object, (ii) identify one or more schedule-item data objects related to the submittal data object, (iii) generate a respective dynamic link between the submittal data object and each of the schedule-item data objects, each schedule-item data object including a respective start date, (iv) receive an indication of a change to a due date of the submittal data object, (v) determine a respective change to the start date of each of the schedule-item data objects based on the respective dynamic link between the submittal data object and the schedule-item data object and the change to the due date of the submittal data object, and (vi) update the start date of each of the schedule-item data objects in accordance with the respective change.

### BACKGROUND

Increasingly, parties involved in construction projects are beginning to use software applications to manage those construction projects. One example of such a software application is the software-as-a-service (SaaS) application for construction management offered by Procore Technologies, Inc. (“Procore”), who is the current applicant. Using construction management software applications such as these, parties can create a digital representation of a given construction project that is to be managed and then create, store, view, and/or interact with various types of digital project data associated with the given construction project. Such digital project data may include specifications, drawings, photos, building information model (BIM) files, requests for information (RFIs), punch lists (e.g., which list work that has not yet been completed or has been completed incorrectly), risk management plans, safety plans, work breakdown structures, change orders, inspection documents (e.g., which record information about the results of inspections), construction submittals (e.g., information that a responsible contractor provides to a general contractor and/or submits to a design team for approval of equipment and/or materials)), construction site observation reports, project management records (e.g., project schedules, schedule items, and project budgets), third-party records (e.g., applicable zoning restrictions, real-estate title records and purchase records, records of public hearings pertinent to the given construction project), directories, invoices, timesheets, meeting minutes, sensor data, and daily logs (e.g., which record information about each day work is done at a work site of the construction project), among many other examples of project data that may be stored for a construction project.

### SUMMARY

Disclosed herein is a new artificial intelligence (AI) architecture for identifying relationships between submittal data objects and schedule-item data objects within a construction management software application and generating dynamic links between them.

In one aspect, the disclosed technology may take the form of a method that involves (i) receiving, from a client device, a request to identify schedule-item data objects within a construction management software application that are related to a submittal data object, (ii) based on the request, identifying one or more schedule-item data objects related to the submittal data object, (iii) generating a respective dynamic link between the submittal data object and each of the one or more schedule-item data objects, each schedule-item data object comprising a respective start date, (iv) receiving an indication of a change to a due date of the submittal data object, (v) determining a respective change to the respective start date of each of the one or more schedule-item data objects based on (a) the respective dynamic link between the submittal data object and the schedule-item data object and (b) the change to the due date of the submittal data object, and (vi) updating the respective start date of each of the one or more schedule-item data objects in accordance with the respective change.

In some examples, generating the respective dynamic link between the submittal data object and each of the one or more schedule-item data objects may involve adding to the submittal data object, a respective pointer to each of the one or more schedule-item data objects.

Still further, in some examples, generating the respective dynamic link between the submittal data object and each of the one or more schedule-item data objects may involve adding, to each of the one or more schedule-item data objects, a respective pointer to the submittal data object.

Still further, in some examples, generating the respective dynamic link between the submittal data object and each of the one or more schedule-item data objects may involve generating, for each of the one or more schedule-item data objects, a respective entry to a link table to represent the respective dynamic link between the submittal data object and the one or more schedule-item data objects.

Still further, in some examples, the method may involve, after identifying the one or more schedule-item data objects, causing the client device to display a respective selectable indication for each of the one or more schedule-item data objects and receiving, from the client device, information indicating a user selection of at least one of the one or more schedule-item data objects to be linked to the submittal data object.

Still further, in some examples, the method may involve, before receiving the indication of the change to the due date of the submittal data object, determining, based on the respective start dates of the one or more schedule-item data objects, the due date of the submittal data object and updating the submittal data object to include the determined due date of the submittal data object.

Still further, in some examples, the method may involve causing the client device to display a respective indication of the determined respective change to the respective start date of each of the one or more schedule-item data objects.

Still further, in some examples, updating the respective start date of each of the one or more schedule-item data objects in accordance with the respective change may involve causing the client device to display a respective selectable indication of the determined respective change to the respective start date of each of the one or more schedule-item data objects and receiving, from the client device, information indicating a user confirmation of the respective indication of the determined respective change to the respective start date of at least one of the one or more schedule-item data objects.

Still further, in some examples, identifying schedule-item data objects related to the submittal data object may involve (i) generating a search query that seeks to identify a candidate set of schedule-item data objects that are related to the submittal data object, (ii) performing a search in accordance with the search query to identify the candidate set of schedule-item data objects, (iii) generating a prompt for a generative AI model that comprises a request to determine which of the candidate set of schedule-item data objects are related to the submittal data object, (iv) passing the prompt to the generative AI model, (v) receiving, from the generative AI model, a prediction of which of the candidate set of schedule-item data objects are related to the submittal data object based on the prompt, and (vi) based on the prediction, determining a final set of schedule item data objects that are related to the submittal data object, wherein the final set comprises the one or more schedule-item data objects.

In another aspect, the disclosed technology may take the form of a computing platform comprising at least one processor, at least one non-transitory computer-readable medium, and program instructions stored on the at least one non-transitory computer-readable medium that are executable by the at least one processor such that the computing platform is configured to carry out the functions of the aforementioned method.

In yet another aspect, the disclosed technology may take the form of a non-transitory computer-readable medium comprising program instructions stored thereon that are executable to cause a computing platform to carry out the functions of the aforementioned method.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### BRIEF DESCRIPTION OF THE DRAWINGS

FIG. 1 depicts an example network configuration in which a construction management software application may be implemented, according to the present disclosure.

FIG. 2A shows a screenshot of a first GUI view of an example submittals tool of a construction management software application.

FIG. 2B shows a screenshot of a second GUI view of the example submittals tool that depicts a selected submittal data object.

FIG. 2C shows an example of a third GUI view of the example submittals tool that depicts an interface through which a user can identify a schedule-item data object that is related to a given submittal data object being created or edited.

FIG. 2D shows a screenshot of a first GUI view of an example schedule tool of a construction management software application.

FIG. 2E shows a screenshot of a second GUI view of the example schedule tool that depicts an interface through which a user can identify an item that is related to a given schedule-item data object.

FIG. 3 shows an example software-based pipeline.

FIG. 4 shows a screenshot of a GUI view of an example submittals tool that presents a selectable indication of related schedule-item data objects.

FIG. 5 shows a screenshot of a GUI view of an example submittals tool that depicts a selected submittal data object and a linked schedule-item data object.

FIG. 6A shows a screenshot of a GUI view of an example schedule tool that depicts a linked submittal data object.

FIG. 6B shows a screenshot of another GUI view of the example schedule tool that depicts dynamic information related to a linked submittal data object.

FIG. 7 illustrates one possible implementation of functionality that may be carried out by the example software-based pipeline of FIG. 3.

FIG. 8 illustrates a simplified block diagram is provided to illustrate some structural components that may be included in an example computing platform that may be configured to perform the platform-side functions disclosed herein.

FIG. 9 illustrates a simplified block diagram is provided to illustrate some structural components that may be included in an example client device that may be configured to perform some of the client-side functions disclosed herein.

### DETAILED DESCRIPTION

The following disclosure refers to the accompanying figures and several examples. One of ordinary skill in the art would understand that such references are for the purpose of explanation only and are therefore not meant to be limiting. Part or all of the disclosed systems, devices, and methods may be rearranged, combined, added to, and/or removed in a variety of manners, each of which is contemplated herein.

As noted above, construction management today is often performed through the use of software applications, such as the software application for construction management provided by Procore Technologies, Inc.®, the applicant of the present disclosure. These construction management software applications generally provide users with the ability to create, store, view, and/or interact with various types of digital data related to a construction project. In practice, these construction management software applications may take various forms.

As one possible implementation, a construction management software application may include both front-end software (e.g., a web application, desktop application, or mobile application) running on client devices that are accessible to individuals associated with construction projects (e.g., contractors, project managers, architects, engineers, designers, etc.) and back-end software running on a back-end computing platform (sometimes referred to as a “cloud” platform) that interacts with and/or drives the front-end software, and which may be operated (either directly or indirectly) by the provider of the front-end software. This form of a software application may be referred to as a client-server application or a software-as-a-service (SaaS) application, among other possibilities. As another possible implementation, a construction management software application may include front-end software that runs on client devices without interaction with a back-end computing platform. These construction management software applications may take other forms as well.

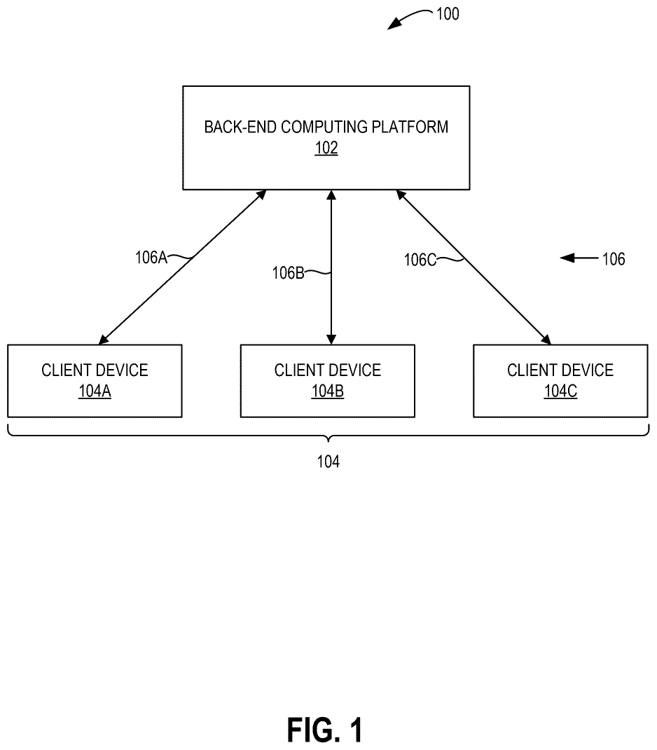

Turning now to the figures, FIG. 1 depicts an example network environment 100 in which a construction management software application may be implemented. As shown in FIG. 1, the network environment 100 includes a back-end computing platform 102 that may be communicatively coupled to one or more client devices 104, which as shown includes the client device 104A, the client device 104B, and the client device 104C. Although the client devices 104 are depicted by three devices as shown for the sake of simplicity in illustration, it should be understood that the client devices 104 may represent more or less than three devices without departing from the spirit and scope of this disclosure.

Broadly speaking, the back-end computing platform 102 may comprise one or more computing systems that have been provisioned with back-end software for a construction management software application, which may include program code for carrying out one or more of the platform-side functions disclosed herein. The one or more computing systems of the back-end computing platform 102 may collectively comprise some set of physical computing resources (e.g., one or more processors, data storage system, communication interfaces, etc.), which may take various forms and be arranged in various manners.

For instance, as one possibility, the back-end computing platform 102 may comprise computing infrastructure of a public, private, and/or hybrid cloud (e.g., computing and/or storage clusters) that has been provisioned with back-end software for the construction management software application. In this respect, the entity that owns and operates the back-end computing platform 102 may supply its own cloud infrastructure or obtain the cloud infrastructure from a third-party provider of “on demand” computing resources, such as Amazon Web Services (AWS) or the like. As another possibility, the back-end computing platform 102 may comprise one or more dedicated servers that have been provisioned with back-end software for the construction management software application.

Further, in practice, the back-end software installed at the back-end computing platform 102 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Further yet, although not shown in FIG. 1, the back-end software installed at the back-end computing platform 102 may interact with a data storage layer of the back-end computing platform 102, which may comprise data stores of various different forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, or streaming event queues, among other possibilities.

The back-end computing platform 102 may comprise various other components and take various other forms as well.

In turn, the client devices 104 may each be any computing device that is capable of running front-end software of the construction management software application, which may include program code for carrying out the client-side functions disclosed herein. In this respect, the client devices 104 may each include hardware components such as one or more processors, computer-readable mediums, communication interfaces, and input/output (I/O) components (or interfaces for connecting thereto), among others, as well as software components that facilitate the client device's ability to run the front-end software (e.g., operating system software, web browser software, etc.). As representative examples, the client devices 104 may each take the form of a desktop computer, a spatial computer, a laptop, a netbook, a tablet, a smartphone, and/or a personal digital assistant (PDA), among other possibilities.

As further depicted in FIG. 1, the back-end computing platform 102 is configured to interact with the client devices 104 over respective communication paths 106, of which communication paths 106A, 106B, and 106C are shown as examples. In this respect, each respective communication path 106 between the back-end computing platform 102 and one of the client devices 104 may generally comprise one or more communication networks and/or communications links, which may take any of various forms. For instance, each respective communication path 106 with the back-end computing platform 102 may include any one or more of Personal Area Networks (PANs), Local-Area Networks (LANs), Wide-Area Networks (WANs) such as the Internet or cellular networks, cloud networks, and/or point-to-point links, among other possibilities. Further, the communication networks and/or links that make up each respective communication path 106 with the back-end computing platform 102 may be wireless, wired, or some combination thereof, and may carry data according to any of various different communication protocols. Further yet, communications over each respective communication path 106 could be carried out via an Application Programming Interface (API), among other possibilities. Still further, although not shown, the respective communication paths 106 between the client devices 104 and the back-end computing platform 102 may also include one or more intermediate systems. For example, it is possible that the back-end computing platform 102 may communicate with a given client device 104 via one or more intermediary systems, such as a host server (not shown). The respective communication paths 106 between the back-end computing platform 102 and the client devices 104 may take other forms as well.

Although not shown in FIG. 1, the back-end computing platform 102 may also be configured to receive data, such as data related to a construction project, from one or more external data sources, such as an external database and/or another back-end computing platform or platforms. Such data sources—and the data output by such data sources—may take various forms.

It should be understood that the network environment 100 depicted in FIG. 1 is one example of a network environment in which a construction management software application may be implemented. Numerous other arrangements are possible and contemplated herein. For instance, other network configurations may include additional components not pictured and/or more or fewer of the pictured components.

When a given party (e.g., a company or individual involved in the construction industry) wishes to utilize an existing construction management software application, the given party may begin by (i) creating an account with the construction management software application and (ii) adding a set of one or more individuals associated with the given party as users on the given party's account. Thereafter, the construction management software application may enable the users of the given party to create, store, view, and/or interact with digital data related to construction projects that involve the given party.

For instance, for each of one or more construction projects that involve the given party, the construction management software application may enable users of the given party to create a new project workspace for the construction project (or join an existing project workspace for the construction project that was previously created) and then (ii) create, store, view, and/or interact with any of various types of digital data objects related to the construction project, which may be referred to herein as “project-related data objects.”

In practice, each different type of project-related data object that is supported by a construction management software application may be designed to serve a particular purpose within the construction management software application and may comprise a particular set of data elements that facilitate that particular purpose. For instance, a first type of project-related data object may be designed to serve a first purpose within the construction management software application and may comprise a first set of data elements, a second type of project-related data object may be designed to serve a second purpose within the construction management software application and may comprise a second set of data elements that differs from the first set of data elements, and so on for each of the other types of project-related data objects. In this way, the users of the construction management software application may utilize different types of project-related data objects to manage different aspects of the construction project.

As some representative examples, the types of project-related data objects that may be supported by a construction management software application may include submittal data objects (e.g., a data object comprising data that represents an item submitted by a responsible contractor to a general contractor of a construction project for review and approval), schedule-item data objects (e.g., a data object comprising data that represents a task, event, or milestone within a schedule for a construction project), photo data objects (e.g., a digital image), observations data objects (e.g., a data object comprising data that represents observed conditions and/or associated effects of said conditions during a construction project at a point in time during the course of the construction project), punch item data objects (e.g., a data object comprising data that represents a work item on a construction project that must be completed to conform to a construction project's contract specifications), daily log data objects (e.g., a data object comprising data that represents construction activity within a given timeframe, such as a day), RFI data objects (e.g., a data object comprising data that represents request for information from one user/party to another user/party and/or the information provided in response to said request), and/or inspection data objects (e.g., a data object comprising data that represents an inspection of a site at some point in time during the course of a construction project), among other types of project-related data objects. In some cases, the construction management software application may also support other types of data objects that are not specific to any particular construction project, such as data objects related to the party or a particular user of the party, among other possibilities.

In at least some implementations, the software features for creating, storing, viewing, and/or interacting with the different types of project-related data objects that are supported by a construction management software application may be arranged into different software “tools” that each correspond to a different type of project-related data object. For instance, a construction management software application may include a “Submittals” tool for creating, storing, viewing, and/or interacting with submittal data objects, a “Schedule” tool for creating, storing, viewing, and/or interacting with schedule-item data objects, a “Task” tool for creating, storing, viewing, and/or interacting with schedule-item data objects, a “Photos” tool for creating, storing, viewing, and/or interacting with photo data objects, an “Observations” tool for creating, storing, viewing, and/or interacting with observations data objects, a “Punch Items/Lists” tool for creating, storing, viewing, and/or interacting with punch list and/or punch item data objects, a “Daily Logs” tool for creating, storing, viewing, and/or interacting with daily log data objects, an “RFIs” tool for creating storing, viewing, and/or interacting with RFI data objects, and/or an “Inspections” tool for creating, storing, viewing, and/or interacting with inspections data objects, among various other examples of software tools that may be included within a construction management software application. However, in other implementations, the software features for creating, storing, viewing, and/or interacting with the different types of data objects that are supported by a construction management software application may be arranged in other manners (e.g., software features that operate across multiple different types of data objects) that are not based solely on a software tools paradigm.

One example software tool that is included in Procore's existing construction management software application is a submittals tool that enables users to create, store, view, and interact with submittal data objects. To facilitate this functionality, the submittals tool provides a GUI comprising several GUI views that enable users to perform these tasks.

For instance, such a submittals tool may present a first GUI view that shows a listing of submittals related to a construction project and allows a user to perform certain actions with respect to the submittal data objects, such as inputting a request to view or edit a submittal data object.

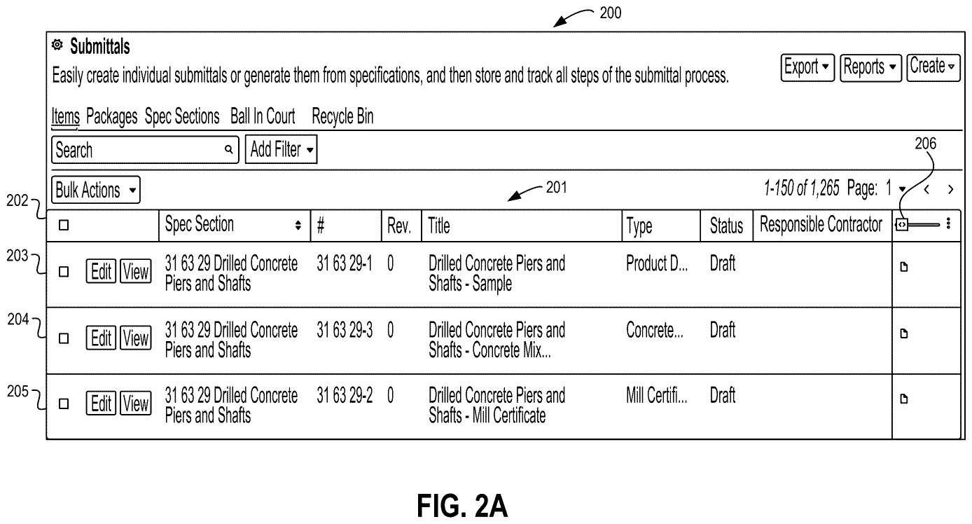

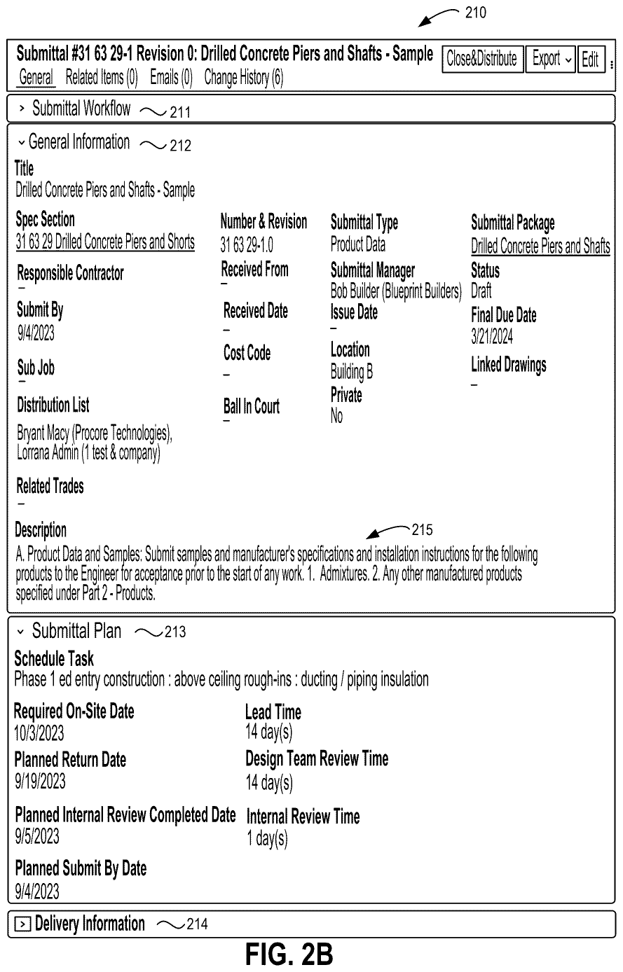

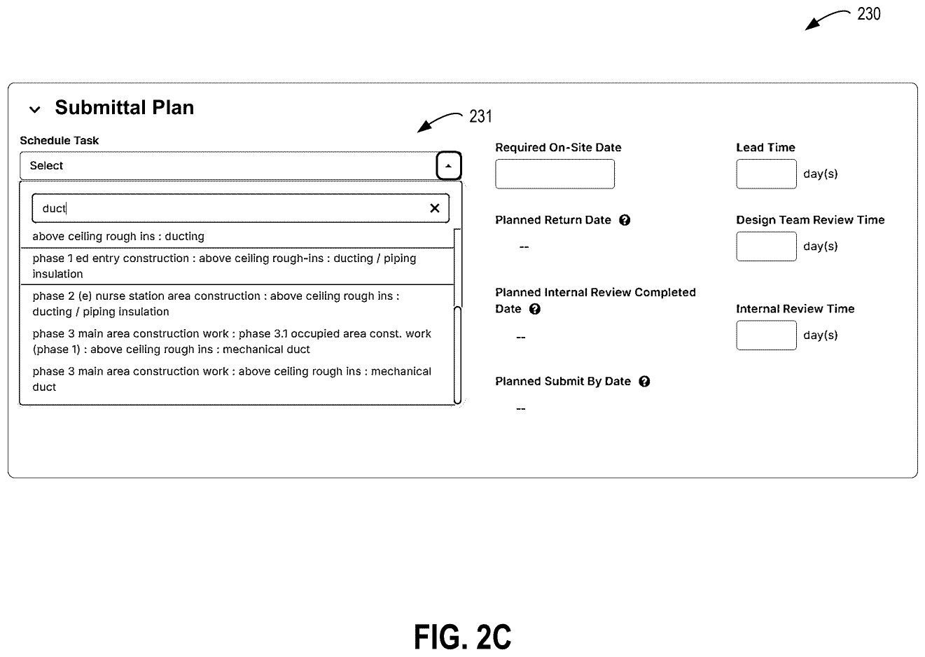

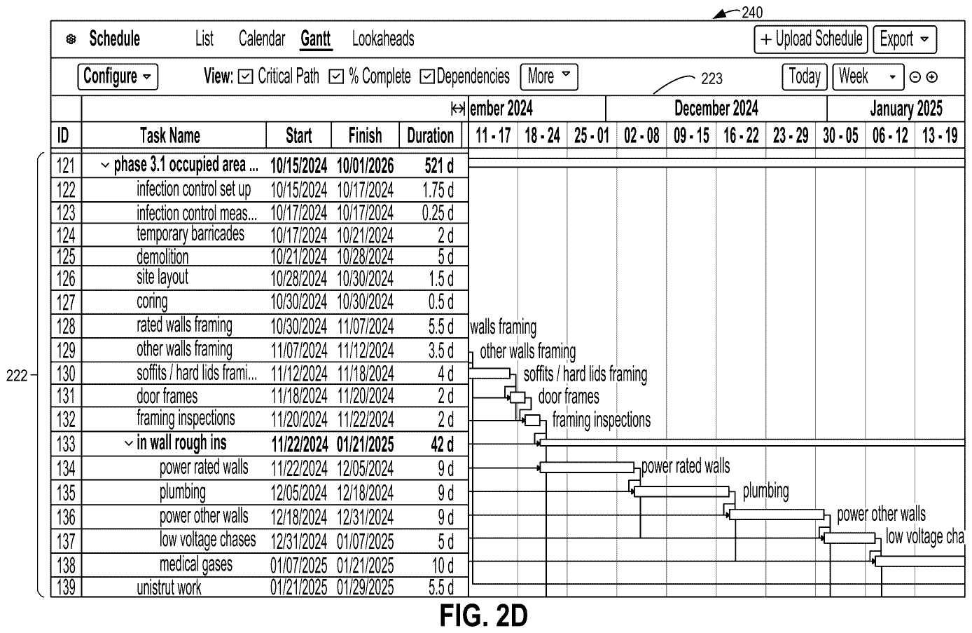

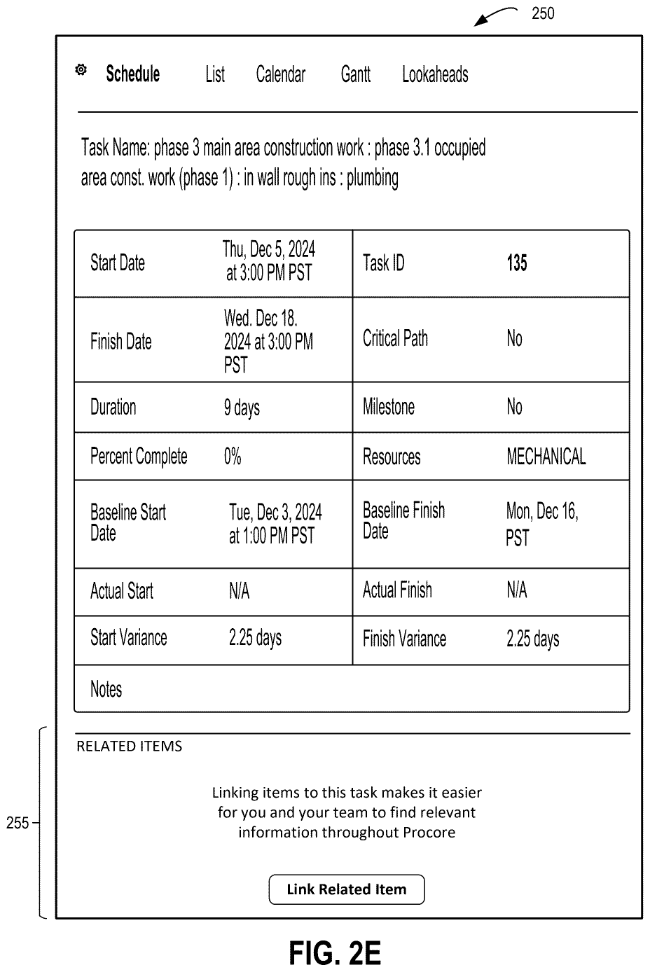

FIG. 2A shows a screenshot of a first GUI view 200 of an example submittals tool. As shown, the first GUI view 200 includes a submittal listing 201 for a given construction project, which comprises line items representing respective submittal data objects that have been created and stored for the given construction project. The submittal listing 201 also includes a header row 202 that identifies the data fields contained within the submittal data objects included in the submittal listing 201. As shown, the header row indicates that there are data fields with names such as “Spec Section” (specification section), “#” (ID number), “Rev.” (revision number), “Title” (submittal title), “Type” (submittal type), “Status” (which indicates whether the submittal has been approved), and “Responsible Contractor” (contractor who is responsible for the submittal). The slider 206 may also be used to reveal additional names of data fields used in submittals (e.g., “Submit by,” “Received From,” and “Approvers,” “Response,” “Sent Date,” “Returned Date,” “Due Date,” “Distributed Date,” “Location,” “Created At,” and “Sub Job”).

As one representative example, the first line item 203 shown in the submittal listing 201 represents a respective submittal data object having (i) a first value for the data field labeled “Spec Section” that is “31 63 29 Drilled Concrete Piers and Shafts,” which indicates that the respective submittal data object relates to a section of the construction specification that is entitled “31 63 29 Drilled Concrete Piers and Shafts”; (ii) a second value that is “31 63 29-1” for the data field labeled “#,” which indicates the that respective submittal data object has the ID number “31 63 29-1,” thereby indicating that the respective submittal data object is the first submittal data object that was created related to the “31 63 29 Drilled Concrete Piers and Shafts” section of the construction specification; (iii) a third value that is “0” for the data field labeled “Rev.,” which indicates that the respective submittal data object has been revised zero times; (iv) a fourth value that is “Drilled Concrete Piers and Shafts—Sample” for the data field labeled “Title,” which indicates that the respective submittal is entitled “Drilled Concrete Piers and Shafts—Sample” (e.g., which suggests that the respective submittal data object refers to a sample of a material that is being submitted for approval to be used in the given construction project); (v) a fifth value that is “Product Data” (abbreviated as “Product D . . . ”) for the data field labeled “Type,” which indicates that the respective submittal data object includes data about a product (e.g., the material) that is being proposed for use in the given construction project; and (vi) a sixth value that is “Draft” for the data field “Status,” indicating that the respective submittal object is a draft (e.g., is not yet a finalized submittal that is ready to be considered for approval).

As another representative example, the second line item 204 shown in the submittal listing 201 represents a respective data submittal object having (i) a first value for the data field labeled “Spec Section” that is “31 63 29 Drilled Concrete Piers and Shafts,” which indicates that the respective submittal data object relates to the section of the construction specification that is entitled “31 63 29 Drilled Concrete Piers and Shafts”; (ii) a second value that is “31 63 29-2” for the data field labeled “#,” which indicates the that respective submittal data object has the ID number “31 63 29-3,” thereby indicating that the respective submittal data object is the third submittal data object that was created related to the “31 63 29 Drilled Concrete Piers and Shafts” section of the construction specification; (iii) a third value that is “0” for the data field labeled “Rev.,” which indicates that the respective submittal data object has been revised zero times; (iv) a fourth value that is “Drilled Concrete Piers and Shafts—Concrete Mix Design” for the data field labeled “Title,” which indicates that the respective submittal is entitled “Drilled Concrete Piers and Shafts—Concrete Mix Design” (e.g., which suggests that the respective submittal data object refers to a design for a concrete mix that is being submitted for approval to be used in the given construction project); (v) a fifth value that is “Concrete Mix Design” for the data field labeled “Type,” which indicates that the respective submittal data object includes data about a concrete mix design that is being proposed for use in the given construction project; and (vi) a sixth value that is “Draft” for the data field “Status,” indicating that the respective submittal object is a draft (e.g., is not yet a finalized submittal that is ready to be considered for approval).

As yet another representative example, the third line item 205 shown in the submittal listing 201 represents a respective data submittal object having (i) a first value for the data field labeled “Spec Section” that is “31 63 29 Drilled Concrete Piers and Shafts,” which indicates that the respective submittal data object relates to the section of the construction specification that is entitled “31 63 29 Drilled Concrete Piers and Shafts”; (ii) a second value that is “31 63 29-2” for the data field labeled “#,” which indicates the that respective submittal data object has the ID number “31 63 29-2,” thereby indicating that the respective submittal data object is the second submittal data object that was created related to the “31 63 29 Drilled Concrete Piers and Shafts” section of the construction specification; (iii) a third value that is “0” for the data field labeled “Rev.,” which indicates that the respective submittal data object has been revised zero times; (iv) a fourth value that is “Drilled Concrete Piers and Shafts—Concrete Mix Design” for the data field labeled “Title,” which indicates that the respective submittal is entitled “Drilled Concrete Piers and Shafts—Concrete Mix Design” (e.g., which suggests that the respective submittal data object refers to a design for a concrete mix that is being submitted for approval to be used in the given construction project); (v) a fifth value that is “Mill Certificate” for the data field labeled “Type,” which indicates that the respective submittal data object includes data about mill certificate (also called a mill test report (MTR)) that verifies the chemical and physical properties of a material that is being proposed for use in the given construction project; and (vi) a sixth value that is “Draft” for the data field “Status,” indicating that the respective submittal object is a draft (e.g., is not yet a finalized submittal that is ready to be considered for approval).

In addition to showing the data-field values for a respective submittal data object, each line item also includes (i) an “Edit” button that allows a user to input a request to edit the respective submittal data object and (ii) a “View” button that allows a user to input a request to view the respective submittal data object.

As shown, the first GUI view 200 also provides the user with the ability to perform other actions with respect to submittal data objects, such as by further including a “Create” button that allows a user to input a request to create a new submittal data object.

When a user inputs a request to view a given submittal data object (e.g., by clicking on the “View” button in one of the line items shown in FIG. 2A), the submittals tool may then present a second GUI view that shows the details of the given submittal data object and enables the user to perform certain actions with respect to the given submittal data object.

FIG. 2B shows a screenshot of a second GUI view 210 of the example submittals tool that may be presented when a user requests to view a given submittal data object. As shown, the second GUI view 210 includes a tile 211 entitled “Submittal Workflow.” The tile 211 is shown in collapsed form, but may be expanded to show details of the workflow for the submittal depicted in the second GUI view 210. For example, in expanded form (not shown), the tile 211 would show a list of people who have been designated to review and approve the submittal.

The second GUI view 210 also includes a tile 212 entitled “General Information.” The tile 211 is shown in expanded form so that a number of data fields and the corresponding values for those data fields are shown. For instance, as was also indicated by the first line item 203 in FIG. 2A, the value for the data field entitled “Status” is “Draft” (which indicates that the submittal is not yet finalized) and the value for the data field entitled “Title” is “Drilled Concrete Piers and Shafts - Sample” (e.g., which suggests that the given submittal data object depicted in FIG. 2B refers to a sample of a material that is being submitted for approval to be used in the given construction project). The names of other data fields and their corresponding values are also shown. For instance, the textual description 215 is the value for the data field entitled “Description.” Also note that a value of “--” for a data field indicates that a user has not specified a value for that data field.

The second GUI view 210 further includes a tile 213 entitled “Submittal Plan Information.” The tile 213 is shown in expanded form. As shown, the tile 213 a data field entitled “Schedule Task,” which a given schedule-item data object that has been identified by a user as being related to the given submittal data object. In this example, the “Schedule Task” data field is shown to have a value of “Phase 1 ed entry construction: above ceiling rough-ins: ducting/piping insulation,” which indicates that the given submittal data object is related to a schedule-item data object of that name that has previously been created for the construction project.

In operation, a user may input an identification of a schedule-item data object that is related to the given submittal data object on either the GUI view for creating the given submittal data object or the GUI view for editing the given submittal data object. An example of a GUI view tile 230 in which the user can identify a schedule-item data object that is related to a given submittal data object being created or edited is shown in FIG. 2C. As shown, the example GUI view tile 230 includes a dropdown element 231 that, when expanded, shows a list of previously created schedule items that can be selected by the user in order to identify one particular schedule item that is related to the given submittal data object.

Returning to FIG. 2B, as shown, the tile 213 of second GUI view 210 also includes data field entitled “Required On-site Date,” “Planned Return Date,” “Planned Internal Review Completed Date,” “Planned Submit By Date,” “Lead Time,” “Design Review Time,” and “Internal Review Time,” which include values that timing information for the given submittal data object. This timing information may at times be referred to as the “submittal plan” for the given submittal data object.

The second GUI view 210 also includes a tile 214 entitled “Delivery Information.” The tile 214 is shown in collapsed form. If expanded, the tile 214 would list a data field entitled “Anticipated Delivery Date” (e.g., the date the material described by the given submittal data object is to be delivered to a site of the given construction project) and a field entitled “Actual Delivery Date” (e.g., the date that the material was actually delivered to a site of the given construction project) and the respective data-field values for each.

The submittals tool may also include a third GUI view (not shown) for creating a new submittal data object. The third GUI view may be presented, for example, when a user requests to create a new submittal data object (e.g., by clicking on the “Create” button shown in FIG. 2A). Like the second GUI view 210, the third GUI view may include data fields that are labeled with the names of the data fields for a submittal data object and allow a user to enter values into the data fields for the new submittal data object that the user wishes to create.

The submittals tool may also include various other GUI views as well.

Another example software tool that is included in Procore's existing construction management software application is a schedule tool that enables users to create, store, view, and interact with schedules comprising schedule-item data objects. To facilitate this functionality, the schedule tool provides a GUI comprising a GUI view that enables users to perform these tasks.

For instance, such a schedule tool may present a GUI view that shows a listing of schedule items related to a construction project and allows a user to perform certain actions with respect to the corresponding schedule-item data objects, such as inputting a request to view or edit a schedule-item data object.

FIG. 2D shows a screenshot of a GUI view 240 of an example schedule tool that depicts a typical Gantt chart for a construction project. As shown, the GUI view 220 includes a schedule-item listing 222 for a given construction project, which comprises line items representing respective schedule-item data objects that have been created and stored for the given construction project. The GUI view 220 also includes a calendar 223 that uses horizontal bars to indicate respective date ranges for the schedule-item data objects indicated by the line items in the schedule-item listing 222. The respective date range for a schedule-item data object may indicate one or more days in which a schedule task represented by the schedule-item data object is expected to be carried out. In addition, the Gantt chart illustrates dependencies between the schedule-item data objects via connections between the blocks.

In operation, a user may select one of the schedule-item data objects in the Gantt chart (e.g., by clicking on the textual description or the horizontal bar) to view more granular information about a particular schedule-item data object. Turning to FIG. 2E, an example of a GUI view 250 of the schedule tool is shown that may be displayed when a user selects the “plumbing” schedule-item data object shown in FIG. 2D. The GUI view 250 includes various data fields of the schedule-item data object and their corresponding values, including an indication of the start date, finish date, duration, and so on.

Further, the GUI view 250 includes a dialog box 255 through which a user may update the schedule-item data object to include an identification of another item within the construction management software application (e.g., a submittal data object) that is related to the given schedule-item data object. As shown, the dialog box 255 includes a selectable button that, when selected, may allow a user to search for and select items that are related to the given schedule-item data object.

The schedule tool may also include various other GUI views as well.

Further, along similar lines, the various other software tools of an existing construction management software application may have respective GUIs that enable users to carry out various actions within those software tools.

While the software design of existing construction management software applications such as the one described above may provide various advantages for its users, existing construction management software applications may still have various technical limitations that negatively impact user experience. One such technical limitation is that existing construction management software applications provide only limited functionality (if any) for identifying relationships between data objects of different types that are created and stored within the construction management software application, despite the fact that there are often real-world relationships (e.g., real-world dependencies) between the construction project tasks corresponding to the data objects of different types that can have a significant impact on the management of a construction project.

For example, schedule tasks are often closely related to submittals on a construction project. If a given schedule task involves using equipment and/or material that meet certain guidelines required by the project specification (e.g., minimum material standards, minimum warranty standards, etc.), the given schedule task typically cannot be commenced (nor completed) until one or more submittals detailing the particular type of equipment and/or material selected for the task is approved (e.g., approved to meet the specification requirements). Thus, submittals play a vital role in planning to have the right materials and information available at the right time and/or at the right place during construction, directly impacting the project's progress. As a result, if approval of a given submittal is delayed past a target start date for one or more schedule tasks that depend on completion of the given submittal, commencement and completion of the given schedule task will also be delayed. By contrast, if a party responsible for approving the submittal could be apprised of this relationship between the given schedule task and the submittal, an appropriate due date for the submittal that precedes the target start date of the schedule task may be established and the party could prioritize approving the submittal in a timeframe that would allow the given schedule task to be commenced on or before the target start date. Moreover, if the start date of a schedule task is moved earlier in time but the party or parties responsible for preparing and/or approving one or more submittals that must be completed prior to starting the schedule task are not aware of this schedule update, it may cause the preparation or approval of one or more of the submittals to be delayed, thereby delaying the schedule task. These types of coordination issues can become significantly more difficult to track when submittals and schedule tasks have a many-to-many relationship, where multiple different submittals can be related to a single schedule task and multiple schedule tasks can be related to one submittal.

However, existing construction management software applications only provide limited functionality, if any, for specifying the relationships between schedule-item data objects and submittal data objects within the construction management software application. For instance, in the submittals tool of Procore's existing construction management software application described above, the only functionality that allows users to specify the relationships between schedule-item data objects and submittal data objects is by using the Schedule Task data field described above and shown in FIG. 2C to identify one particular schedule-item data object that is related to a submittal data object. However, this existing functionality has a number of limitations, including that (i) it only allows a user to identify a single schedule-item data object that is related to the submittal data object despite the fact that there may be multiple different schedule-item data objects that are related to the submittal data object, (ii) it relies on the user to identify which schedule-item data object is related to the submittal data object, which gives rise to inaccurate and/or incomplete identifications of relationships between schedule-item and submittal data objects, and (iii) the only functional purpose served by the user-identified schedule-item data object is that this information may subsequently be displayed to users who are viewing submittals in the submittals tool. For instance, the identification of the selected schedule-item data object within the submittal data object does not create a logical connection or any other type of dynamic relationship between the two data objects (e.g., by enforcing or suggesting a dependency between respective dates of the two data objects), nor does it update the identified schedule-item data object in any way (e.g., by adding a corresponding identification of the submittal data object to the schedule-item data object). As a result, no functionality is carried out to connect and maintain a relationship between the two data objects within the construction management software application in a way that facilitates further functional interactions or interdependency between them. Among other things, a user must rely on their own awareness of the related schedule-item data object to select dates in a delivery plan for the submittal (e.g., submit by date, a due date, etc.) that are compatible with the schedule-item data object.

In a similar way, the schedule tool of Procore's existing construction management software application provides only limited functionality that allows users to specify the relationships between a given schedule-item data object and other items. In particular, the Related Items tile 235 shown in FIG. 2E may allow a user to identify a related item (e.g., a submittal data object) that the user decides is related to the schedule-item data object. However, this existing functionality has similar limitations to those described above, in that (i) it relies on the user to identify which items are related to the schedule-item data object, which gives rise to inaccurate and/or incomplete identifications of relationships between schedule-item and submittal data objects, and (ii) the only functional purpose served by the user-identified related items is that this information may subsequently be displayed to users who are viewing schedule-item data object in the schedule tool. For instance, the identification of the related items within the Related Items tile 235 of the schedule-item data object does not create a logical connection or any other type of dynamic relationship between the related item(s) and schedule-item data object, nor does it update the related item(s) in any way (e.g., by adding a corresponding identification of the schedule-item data object to the related item(s)). As a result, no functionality is carried out to connect the related item(s) with the schedule-item data object within the construction management software application in a way that facilitates further functional interactions or interdependency between them.

This disconnect between the Schedule tool and Submittals tool within Procore's current construction management software application creates significant challenges for users. Changes that occur to data objects in one tool that should affect related data objects in the other tool are not reflected, which can lead to missed deadlines and delays. This in turn can lead to ripple effects on a project's overall timeline due to this lack of functionality.

To address these and other technical problems associated with existing construction management software applications, disclosed herein is an artificial intelligence (AI) architecture for identifying relationships between submittal data objects and schedule-item data objects within a construction management software application and generating dynamic links between them. At a high level, the disclosed AI architecture may comprise a plurality of AI agents that are each preconfigured to perform particular AI-based functionality for determining relationships between schedule-item data objects and a given submittal data object in response to a request by a user and encoding the determined relationships in a way that enables a construction management software application to generate notifications when a change to one data object impacts a related data object. The components of the disclosed AI architecture are described in further detail below.

The disclosed AI architecture may improve upon the existing construction management software applications in various ways. For example, the disclosed AI architecture provides a framework for automatically, accurately, and efficiently identifying relationships between submittal data objects and schedule-item data objects within a construction management software application and generating dynamic links between them, which improves over the limited functionality of existing construction management software applications for meaningfully connecting submittal data objects with schedule-item data objects that is described above. This allows the construction management software application to surface notifications to users and/or make automatics updates when a change to one data object may impact others, all of which in turn serves to help manage the construction project schedule and submittals more effectively by avoiding delays, reducing uncertainty, and quickly implementing project updates when necessary. The disclosed AI architecture also provides other improvements over the existing construction management software applications, as will be appreciated based on the discussion that follows.

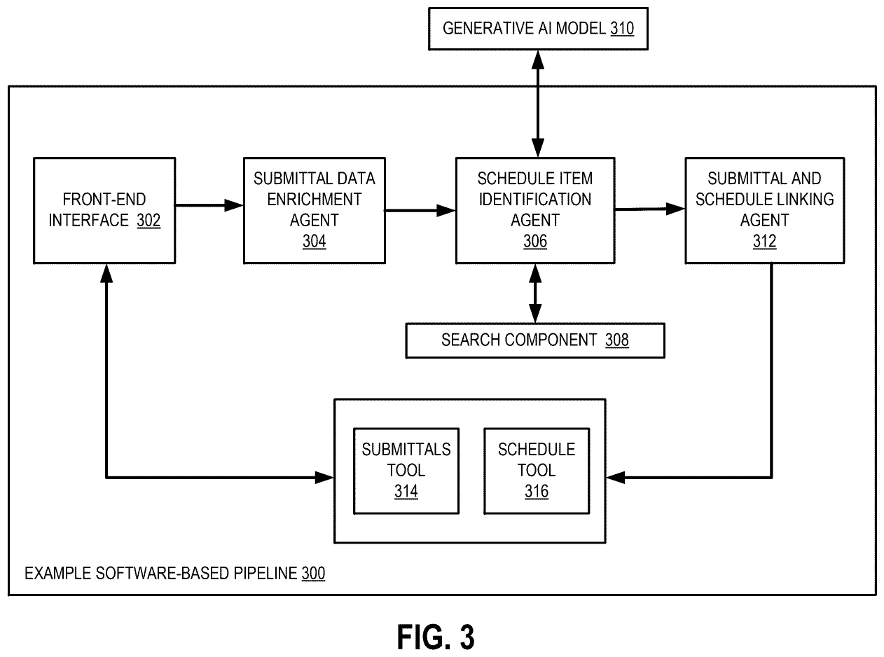

Turning now to FIG. 3, an example of the disclosed software-based pipeline 300 comprising the disclosed AI architecture is illustrated. In practice, the example software-based pipeline 300 may be encoded in the form of program instructions that are executable by one or more processors of a computing platform, and for purposes of illustration, the example software-based pipeline 300 is described as being installed on and executed by the back-end computing platform 102 of FIG. 1 that is running back-end software for a construction management software application, but it should be understood that the example software-based pipeline 300 may be installed on and executed by any one or more computing platforms that are capable of performing the example operations of the example software-based pipeline 300. Further, it should be understood that the example software-based pipeline 300 is merely described in this manner for the sake of clarity and explanation and that the example operations may be implemented in various other manners, including the possibility that operations may be added, removed, rearranged into different orders, combined into fewer blocks, and/or separated into additional blocks depending upon the particular example.

As shown in FIG. 3, the example software-based pipeline 300 comprises a front-end interface 302, a submittal data enrichment agent 304, a schedule item identification agent 306, a search component 308, and a submittal and schedule linking agent 312, among other possible components that may be included in the example software-based pipeline 300. Additionally, as shown in FIG. 3, the example software-based pipeline 300 may interface with at least one generative AI model 310, which may either be hosted on a separate computing platform that is accessible over a network-based communication path (e.g., via an API or the like) or be hosted on the back-end computing platform 102. Further, the example software-based pipeline 300 may interface with the submittals tool 314 and the schedule tool 316 of the construction management software application running on the back-end computing platform 102. Each of these components will now be described in further detail.

To begin, the front-end interface 302 generally functions to interface with client devices running the front-end software for the construction management software application, such as the client devices 104 of FIG. 1, so as to receive communications from the client devices 104 via the communication paths 106 and/or send communications to the client devices 104 via the communication paths 106. For instance, at a high level, the functionality performed by the front-end interface 302 in accordance with the present disclosure may involve (i) receiving, from a client device, information indicating a submittal data object supported by the construction management software application, (ii) passing the submittal data object to the submittal data enrichment agent 304, (iii) receiving a response from the submittal data enrichment agent 304, and (iv) sending the response to the client device 104 and thereby causing the client device 104 to present the response to the user.

The submittal data object may represent a submittal of any of various forms. Some industry standards (e.g., CSI SectionFormat-2007) define standardized categories for different types of submittals, although such categories may vary. In general, a submittal refers to a collection of informational elements (e.g., written documentation such as cut sheets, material safety data sheets, material submittal sheets, product manuals, test results, Health and Safety Plans (HASPs); image documentation such as photos and shop drawings; etc.) and/or physical elements (e.g., material samples, product samples, equipment samples, physical models etc.) that describes a proposed plan of action (e.g., to use a particular building material, use a particular piece of equipment, apply a particular process, etc.) and is submitted (e.g., by a responsible contractor) to a stakeholder (e.g., a general contractor, a design team, an owner) for approval before the plan of action is carried out.

Further, in practice, the information indicating the submittal data object that is received by the front-end interface 302 may be sent by the client device 104 based on user input that is received by the client device 104 and may take various forms. For instance, as one possibility, a user may access and use the front-end software running on the client device 104 to input data for creating the submittal data object (e.g., via the submittals tool 314). This may cause the back-end platform 102 to create the submittal data object, which in turn may be a trigger that causes the submittal data object to be sent to the submittal data enrichment agent 304. As another possibility, a user may access and use the front-end software running on the client device 104 to interact with one or more input-control elements that, when selected, initiate a request to detect schedule item objects that are related to a submittal data object that already exists within the construction management software application running on the back-end computing platform 102, and to link the detected schedule-item data objects to the related submittal data object within the construction management software application. In either case, the client device 104 may then encode the user's request into a communication that is sent to the back-end computing platform 102. In practice, this communication may take the form of one or more messages (e.g., one or more HyperText Transfer Protocol (HTTP) messages) that are sent over the communication path 106 between the client device 104 and the back-end computing platform 102, and in at least some implementations, the communication may be sent via one or more APIs.

The front-end interface 302 may perform other functions as well.

Further, in other implementations, the front-end interface 302 may be configured to pass requests to and/or receive responses from other components of the software-based pipeline 300 in addition to the submittal data enrichment agent 304.

In accordance with the present disclosure, the submittal data enrichment agent 304 may take the form of a software component that is preconfigured to perform functionality in order to enrich submittal data objects with data that will facilitate enhanced detection of relationships between submittal data objects and schedule-item data objects. In some implementations, the submittal data enrichment agent 304 may be implemented in the form of a discrete executable software component, which is how the submittal data enrichment agent 304 is shown in FIG. 3 and described below for purposes of illustration. However, it should be understood that in other implementations, the submittal data enrichment agent 304 may be implemented in the form of a discrete configuration file (e.g., a Yet Another Markup Language (YAML) file) that, when loaded and executed by a centralized execution engine (e.g., an agent executor), causes the centralized execution engine to perform the functions for the submittal data enrichment agent 304. The submittal data enrichment agent 304 may take other forms as well.

At a high level, the functionality that the submittal data enrichment agent 304 performs to enrich the submittal data object may involve (i) receiving information indicating the submittal data object from the front-end interface 302, (ii) enriching the submittal data object, and (iii) passing the resulting enriched submittal data object to the schedule item identification agent 306. The manner in which the submittal data enrichment agent 304 enriches the submittal data object may take any of various forms.

In one implementation, prior to the enrichment performed by the submittal data enrichment agent 304, a dataset of tokens (e.g., keywords, phrases, index terms, and/or numbers) associated with certain construction activities may be built ahead of time for the purpose of providing better information to describe the subject matter of submittals. The manner in which the dataset of tokens is created may take any of various forms.

For instance, as one possibility, a set of construction activities may be defined. The set of construction activities may be defined by an industry standard. For instance, the activity codes (also called “cost codes”) defined by the Construction Specifications Institute (CSI) may be used as the set of construction activities. Alternatively, the set of construction activities may be defined in some other way (e.g., ad hoc, by applying a clustering technique to historical data to identify clusters of different types of construction actions such that each cluster would define a type of construction activity, and/or based on manual user input, etc.).

For each construction activity, a respective set of tokens that are correlated with the construction activity may be determined. The manner in which the correlations between a construction activity and the tokens in its respective set of tokens are determined may take any of various forms.

In one example, for a given construction activity, tokens that describe resources (e.g., equipment, trades, materials, etc.) that are frequently used in the given construction activity may be added to the respective set of tokens. For instance, if the given construction activity is “Masonry,” tokens for tradespersons (e.g., “mason,” “brickmason,” “brick mason,” “blockmason,” “block mason,” “bricklayer,” “brick layer,” etc.), building materials (e.g., “mortar,” “brick,” “stone”), tools (e.g., “trowel,” “jointer,” “plumb bob,” “mason's level,” “masonry drill bit”, “brick hammer,” “hammer drill,” “chisel,” “masonry saw,” “grinder,” “diamond blade,” etc.), actions (e.g., “pointing,” “tuckpointing,” “repointing,” “brick pointing,” “chiseling,” etc.), safety equipment (e.g., “face mask,” “filter,” etc.), safety hazards (e.g., “mortar dust,” “silica dust,” “respirable silica,” etc.), and/or other context associated with masonry activities may be added to the respective set of tokens for the given construction activity.

In another example, if the construction activities have been defined in accordance with an industry standard, tokens that are associated with the given construction activity in the industry standard may be added to the respective set of tokens. For instance, if the given construction activity is “Masonry” and the CSI activity codes are utilized as the definitions for construction activities, tokens such as the CSI activity code for masonry (“04 00 00”), the CSI sub codes for masonry (“04 01 00,” “04 05 00,” etc.), and/or the CSI sub code descriptions for masonry (e.g., “vitrified clay liner plate,” “exposed aggregate concrete unit masonry,” “adobe unit masonry,” “multiple-wythe unit masonry,” “flue liner masonry,” etc.) may be added to the respective set of tokens for the given activity.

In yet another example, tokens that describe a phase of a construction project in which the given construction activity typically occurs may be added to the respective set of tokens. For instance, in one example, the phases of a construction project may be defined as “1. Preconstruction,” “2. Sitework and Foundation,” “3. Rough Framing,” “4. Exterior Construction,” “5. MEP (Mechanical, Electrical, Plumbing),” and “6. Finishes and Fixtures.” Other examples are also possible.

In yet another example, historical data from submittals in one or more construction projects may be used to populate the respective sets of tokens for the defined construction activities. For instance, if the given construction activity is “Masonry,” historical submittal data objects (e.g., from previous construction projects) that have been classified under masonry may be collected to create a set of training data. Next, a natural-language processing (NLP) technique, such as bag-of-words (e.g., Latent Dirichlet Allocation), Term Frequency-Inverse Document Frequency (TF-IDF), etc., may be applied to the set of training data to identify tokens (e.g., words) that are commonly found in submittal data objects. The tokens identified by applying the NLP technique to the set of training data may be added to the respective set of tokens for the given construction activity.

The manner in which the respective sets of tokens for the construction activities are determined may also take other forms.

The construction activities and the respective sets of tokens may be stored in a retrieval structure (e.g., a database, a hash table, etc.) that maps each construction activity to its respective set of tokens such that, when a given construction activity is provided, the given construction activity's respective set of tokens can be retrieved from storage in the retrieval structure without having to be redetermined.

Returning to the submittal data enrichment agent 304, the submittal data object that the submittal data enrichment agent 304 receives may have been assigned a construction activity beforehand (e.g., in the form of a CSI code at the time of creation). In order to enrich the submittal data object that was received, the submittal data enrichment agent 304 may (i) identify a given construction activity assigned to the submittal data object, (ii) retrieve the respective set of tokens for the given construction activity from the retrieval structure, and (iii) enrich the submittal data object with the respective set of tokens.

The manner in which the submittal data enrichment agent 304 enriches the submittal data object with the respective set of tokens may take any of various forms. In one example, the submittal data enrichment agent 304 may add the respective set of tokens to one or more data fields of the submittal data object. For instance, the submittal data enrichment agent 304 may add (e.g., append) the respective set of tokens to the data-field value for a description field of the submittal data object). The manner in which the submittal data enrichment agent 304 enriches the submittal data object with the respective set of tokens may also take other forms.

Other implementations are also possible.

Turning now to the schedule item identification agent 306, enriched submittal data object may be received from the data enrichment agent 304 as described above. The schedule item identification agent 306 may take the form of a software component that provides an interface to a respective AI model (e.g., the generative AI model 310) and is preconfigured to identify schedule-item data objects that are related to submittal data objects. In some implementations, the schedule item identification agent 306 may be implemented in the form of a discrete executable software component, which is how the schedule item identification agent 306 is shown in FIG. 3 and described below for purposes of illustration. However, it should be understood that in other implementations, the schedule item identification agent 306 may be implemented in the form of a discrete configuration file (e.g., a YAML file) that, when loaded and executed by a centralized execution engine (e.g., an agent executor), causes the centralized execution engine to perform the functions for the schedule item identification agent 306. The schedule item identification agent 306 may take other forms as well.

At a high level, the AI-based functionality that the schedule item identification agent 306 performs to identify schedule-item data objects that are related to submittal data objects may involve (i) receiving, from the submittal data enrichment agent 304, a an enriched submittal data object, (ii) generating, for the enriched submittal data object, one or more search queries that seek to identify a candidate set of schedule-item data objects that are related to the enriched submittal data object, (iii) providing the one or more search queries to the search component 308, (iv) receiving search results back from the search component 308 comprising a candidate set of schedule-item data objects, (v) generating a prompt for the generative AI model 310 that comprises a request to determine which of the schedule-item data objects in the candidate set are related to the enriched submittal data object, (vi) passing the prompt as input to the generative AI model 310, (vii) receiving a response from the generative AI model 310 comprising a prediction of which schedule-item data objects are related to the enriched submittal data object, (viii) using that prediction as a basis for determining a final set of schedule-item data objects that are related to the enriched submittal data object, and (ix) passing an identification of the final set of schedule-item data objects to the submittal and schedule linking agent 312. Each of these functions may take any of various forms.

To begin, the schedule item identification agent 306's function of receiving the enriched submittal data object may involve receiving enriched submittal data object from the submittal data enrichment agent 304 via an internal communication path (e.g., an internal API, a messaging queue or bus, or some other form of inter-process communication).

In turn, the schedule item identification agent 306's function of generating the one or more search queries that seek to identify the candidate set of schedule-item data objects that are related to the enriched submittal data object may take any of various forms, which may depend in part on the type of search that is to be performed.

As one possibility, if the search to be performed comprises a text-based search (e.g., as discussed further below with respect to the search component 308), then generating the one or more search queries may comprise (i) identifying, for each of one or more data fields (e.g., formal parameters) defined for submittal data objects, a respective value (e.g., actual parameters) for the enriched submittal data object and (ii) generating a text-based search query that includes the respective values for the one or more data fields. Since the enriched submittal data object has been enriched, the respective set of tokens that were added to the enriched submittal data object by the submittal data enrichment agent 304 will be included in the text-based search query (e.g., as a result of having been added to one or more data fields of the enriched submittal data object.

For example, consider a scenario in which submittal data objects have a project identifier (ID) data field, a company ID data field, a standardized code data field, a title data field, a description data field, a type data field, and a due-date data field. In this scenario, the schedule item identification agent 306 may identify respective values for these data fields. For example, if the enriched submittal data object is in a data interchange format (e.g., Javascript Object Notation (JSON)), the schedule item identification agent 306 may identify the respective values for these data fields by parsing the enriched submittal data object. In another example, if the enriched submittal data object is in the form of an instantiated instance of an object class (e.g., that has been coded in an object-oriented programming language such as Python, C #, Java, C++, etc.), the schedule item identification agent 306 may identify the respective values for these data fields by calling one or more class methods of the object class via the enriched submittal data object.

As another possibility, if the search to be performed comprises an embedding-based semantic search (e.g., as discussed further below with respect to the search component 308), then the function of generating the one or more search queries may involve (i) transforming the enriched submittal data object into a set of one or more embeddings (also referred to as “vector embeddings” or simply “vectors”) and then (ii) generating an embedding-based search query that includes the set of one or more embeddings. In this respect, the function of function of transforming the enriched submittal data object into a set of one or more embeddings may take any of various forms, and in at least some implementations, may involve (i) pre-processing the enriched submittal data object so as to place it into a form that can be input into an embedding model, such as by extracting certain data alphanumeric values from the enriched submittal data object (e.g., including values found in the respective set of tokens that was added to the enriched submittal data object) and placing them into an alphanumeric text string and/or preparing an image for input to the embedding model, and then (ii) inputting the pre-processed version of the enriched submittal data object (e.g., the alphanumeric text string or the image) into the embedding model that functions to generate the set of one or more embeddings. Since the respective set of tokens were added to the enriched submittal data object by the submittal data enrichment agent 304, the set of one or more embeddings includes one or more embeddings that represent the tokens in the respective set.

However, in other implementations, it is possible that the schedule item identification agent 306 may pass the enriched submittal data object (or a pre-processed version thereof) to the search component 308, which may then function to generate the text-based and/or embedding-based search queries.

In at least some implementations, if the enriched submittal data object is linked to other data objects, the schedule item identification agent 306 may also carry out similar functions with respect to the linked data objects.

It should also be understood that if multiple different types of searches are to be run by the search component 308, then the schedule item identification agent 306 may function to generate multiple different types of search queries, such as both a text-based search query and an embedding-based search query.

The function of generating the one or more search queries may also take other forms.

Returning to the functionality of the schedule item identification agent 306, the schedule item identification agent 306's functions of providing the one or more search queries to the search component 308 and then receiving the search results back from the search component 308 may involve sending the one or more search queries to and receiving the search results from the search component 308 via an internal communication path (e.g., an internal API, a messaging queue or bus, or some other form of inter-process communication).

Next, the schedule item identification agent 306's function of generating the prompt for the generative AI model 310 may take any of various forms. For instance, as one possibility, this function may involve generating a prompt that incudes (i) an identification of the enriched submittal data object, (ii) an identification of the candidate set of schedule-item data objects, (iii) a request for the generative AI model 310 to determine which of the candidate set of schedule-item data objects are related to the enriched submittal data object in a particular way (e.g., the schedule-item data object depends on completion of the enriched submittal data object), and perhaps also (iv) additional data that may be utilized by the generative AI model 310 when performing the task of determining which of the candidate set of schedule-item data objects are related to the enriched submittal data object, among other possible aspects of the prompt that may be generated by the schedule item identification agent 306. Each of these aspects of the prompt may take any of various forms.

For instance, the identification of the enriched submittal data object may comprise respective values for any of various data fields contained within the enriched submittal data object, examples of which may include a name (e.g., a title) of the enriched submittal data object, a description of the enriched submittal data object, a start, end, and/or due date of the enriched submittal data object (if applicable), and/or other values that are extracted from or otherwise derived based on the enriched submittal data object, among other possible examples.

Similarly, the identification of the candidate set of schedule-item data objects may comprise respective values for any of various data fields contained within schedule data objects found in the candidate set, examples of which may include names (e.g., titles) of the schedule-item data objects, descriptions of the schedule-item data objects, start, end, and/or due dates of the schedule-item data objects (if applicable), and/or other values that are extracted from or otherwise derived based on the candidate set of schedule-item data objects, among other possible examples.

Further, the request for the generative AI model 310 to determine which of the candidate set of schedule-item data objects are related the enriched submittal data object may take any of various forms, and in at least some implementations, the request may comprise a natural-language query in a form such as “Which of the [candidate set of schedule-item data objects] depend on completion of [the enriched submittal data object]?” a natural-language instruction in the form of “Determine which of the [candidate set of schedule-item data objects] depend on completion of [the enriched submittal data object],” or a natural-language instruction of “determine which of the [candidate set of schedule-item data objects] should not be completed before [the enriched submittal data object] is approved,” among other possibilities.

Further yet, the additional data that may optionally be included in the prompt may take any of various forms. For instance, as one possibility, the prompt may optionally include an identification of a particular role that the generative AI model 310 should utilize when performing the task of determining which of the candidate set of schedule-item data objects are related to the enriched submittal data object, such as a particular persona that the generative AI model 310 should take on or a particular perspective from which the generative AI model 310 should interpret the request. In this respect, the prompt that is generated by the schedule item identification agent 306 could optionally specify that the generative AI model 310 should interpret the request from the perspective of a particular type of construction professional, such as a contractor, a project manager, a project superintendent, a project foreman, etc., among other possible types of construction professionals. To illustrate with a particular example, the prompt could include the phrase “You are a contractor working for a construction company” in order to specify that the generative AI model 310 should interpret the request from the perspective of contractor working for a construction company. Many other examples are possible as well.

As another possibility, the prompt may optionally include a description of certain guidelines that the generative AI model 310 should utilize when performing the task of determining which schedule-item data objects in the candidate set are related to the enriched submittal data object. These guidelines may take any of various forms.

One example category of guidelines that may optionally be included in the prompt may comprise guidelines for how to assess the relatedness between schedule-item data objects and the enriched submittal data object, such as guidelines specifying which values for data fields to assess and how to determine when those values indicate relatedness between schedule-item data objects and the enriched submittal data object.

Another example category of guidelines that may optionally be included in the prompt may comprise guidelines for how confident the generative AI model 310 should be in its identification of the related schedule-item data objects in order to include such schedule-item data objects in the response. Some representative examples of this category of guidelines may include instructions of “if unsure about a value, do not provide a result,” “do not include schedule items that match the submittal with a confidence level of less than fifty percent,” and/or “include the schedule items whose match scores are among the top five match scores,” among other possible.

Yet another example category of guidelines that may optionally be included in the prompt may comprise guidelines for what sources of data should be utilized by the generative AI model 310 when identifying the related schedule-item data objects. Some representative examples of this category of guidelines may include an instruction to limit the identification of the related schedule-item data objects to the candidate set of schedule-item data objects and an instruction to avoid using information from unverified sources, among other possible examples.

Still another example category of guidelines that may optionally be included in the prompt may comprise guidelines for how the generative AI model 310 is to handle errors (e.g., unexpected programmatic behavior such as exceptions, timeouts, etc.). Some representative examples of this category of guidelines may include instructions of “if the function response contains an error or there are no results, handle it gracefully by informing the user,” “record any exceptions that occur in a log file,” and/or “if network connectivity is interrupted, inform the user and notify the user when network connectivity is restored,” among other possible examples.

Other categories of guidelines may optionally be included in the prompt as well.

As still another possibility, the prompt may optionally include examples of relationships between schedule-item data objects that depend on the completion of submittal data objects, which may be utilized by the generative AI model 310 to help guide its task of determining which of the schedule-item data objects in the candidate set are related to the enriched submittal data object.

As a further possibility, the prompt may optionally include other contextual data that the generative AI model 310 should utilize as context for the task of determining which of the candidate set of schedule-item data objects are related to the enriched submittal data object, such as additional background details, facts, or the like that may be relevant to the identification of the related schedule-item data objects (e.g., background details about the construction project).

As still a further possibility, the prompt may optionally include a specification of the output format that is to be utilized by the generative AI model 310 when generating the response (e.g., the layout and/or structure of the response). As representative examples, the specification of the output format may comprise instructions such as “provide the matching schedule items in a list that is sorted in descending order according to the respective confidence levels you determine for those matching schedule items,” “provide a structured list of schedule items related to the submittal according to the output schema,” or “List the matching schedule items as rows in a table that includes columns for the ID number data field, the title data field, and the description data field,” among other possible examples.

The function of generating the prompt for the generative AI model 310 may also take other forms.

Returning again to the functionality of the schedule item identification agent 306, the schedule item identification agent 306's functions of passing the generated prompt to the generative AI model 310 and receiving the response from the generative AI model 310 comprising the prediction of which schedule-item data objects are related to the enriched submittal data object may take any of various forms, which may depend in part on where the generative AI model 310 is hosted. For instance, in an implementation where the generative AI model 310 is hosted on a separate computing platform from the back-end computing platform 102, these functions may involve sending the generated prompt to the generative AI model 310 over an external network-based communication path (e.g., via an API or the like) and then receiving the response from the generative AI model 310 over the external network-based communication path. Alternatively, in an implementation where the generative AI model 310 is hosted on the back-end computing platform 102, these functions may involve sending the generated prompt via an internal communication path (e.g., an internal API, a messaging queue or bus, or some other form of inter-process communication) and then receiving the response from the generative AI model 310 over the internal communication path. The functions the schedule item identification agent 306 performs to pass the generated prompt to the generative AI model 310 and to receive the response from the generative AI model 310 may take other forms as well.

In turn, the schedule item identification agent 306's function of using the prediction from the generative AI model 310 as the basis for determining the final set of schedule-item data objects that are related to the enriched submittal data object may take any of various forms. For instance, as one possibility, this function may involve determining a final set of schedule-item data objects that includes all of the schedule-item data objects that were predicted to be related by the generative AI model 310. As another possibility, this function may involve determining a final set of schedule-item data objects that includes less than all of the schedule-item data objects that were predicted to be related by the generative AI model 310, such as by filtering the list of data objects returned by the generative AI model 310 based on factors such as a target number of schedule-item data objects to include in the response, a threshold confidence level for the relatedness prediction, or the like. As still another possibility, this function may involve identifying additional schedule-item data objects to include in the final set of schedule-item data objects beyond those that are predicted to be related by the generative AI model 310, such as by identifying additional schedule-item data objects that are similar to the schedule-item data objects that were predicted to be related by the generative AI model 310. The function of using the prediction from the generative AI model 310 as the basis for determining the final set of schedule-item data objects that are related to the enriched submittal data object may take other forms as well.

Lastly, the schedule item identification agent 306's function of passing the identification of the final set of schedule-item data objects to the submittal and schedule linking agent 312 may involve sending the identification of the final set of schedule-item data objects to the submittal and schedule linking agent 312 via an internal communication path (e.g., an internal API, a messaging queue or bus, or some other form of inter-process communication). In this respect, the identification of the final set of data objects schedule-item data objects may take any of various forms, including but not limited to a textual description (e.g., a name), a numerical identifier, and/or link to each of the schedule-item data objects in the final set.

In some implementations, the functionality of the schedule item identification agent 306 may take an alternative form in which the schedule item identification agent 306 does not generate the one or more search queries mentioned above for the enriched submittal data object, nor provide such search queries to the search component 308, nor receive search results back from the search component 308. Instead, at a high level in this alterative, the AI-based functionality that the schedule item identification agent 306 performs to identify schedule-item data objects that are related to submittal data objects may involve (i) receiving, from the submittal data enrichment agent 304, an enriched submittal data object, (ii) generating, for the enriched submittal data object, a prompt for the generative AI model 310 that comprises (a) the enriched submittal data object (e.g., in a text-based form, and embedding form, or both), (b) the full set of schedule-item data objects to be searched (e.g., in text-based form, in the form of a full embedding model including the full set of embedded schedule-item data objects, or both), (c) a request to determine the schedule-item data objects that depend on completion of the enriched submittal data object and should be logically linked with the enriched submittal data object, and (d) additional data that may be utilized by the generative AI model 310 when performing the task of determining which of the schedule-item data objects in the candidate set are related to the enriched submittal data object, among other possible aspects of the prompt that may be generated by the schedule item identification agent 306. Each of these aspects of the prompt may take any of the various forms discussed above.

Furthermore, in this alternative, the generative AI model 310 may generate one or more search queries based on the prompt, provide the one or more search queries to the search component 308, receive search results back from the search component 308 comprising a candidate set of schedule-item data objects, refine the candidate set into a final set of schedule-item data objects that are related to the enriched submittal data object with at least a threshold level of confidence, and pass the final set of schedule-item data objects to the schedule item identification agent 306.

Further yet, in this alternative, functionality of the schedule item identification agent 306 may further involve (iii) passing the prompt as input to the generative AI model 310, (iv) receive a response from the generative AI model 310 comprising a prediction of which schedule-item data objects are related to the submittal data object, (v) using that prediction as a basis for determining a final set of schedule-item data objects that are related to the enriched submittal data object, and (vi) passing an identification of the final set of schedule-item data objects to the submittal and schedule linking agent 312. Each of these functions may take any of the various forms discussed above.

The functionality of the schedule item identification agent 306 may also take various other forms.

The search component 308 generally functions to (i) receive one or more search queries that seek to identify a candidate set of schedule-item data objects that are related to a submittal data object, (ii) perform a search in accordance with the one or more search queries, and (iii) return search results to the component from which the one or more search queries were received (e.g., the schedule item identification agent 306 or the generative AI model 310).

In this respect, the one or more search queries that may be received by the search component 308 may take any of various forms, including but not limited to any of the forms previously described.

Further, the search component's function of performing the search in accordance with the one or more search queries may take any of various forms. For purposes of illustration, the functionality of the search component 308 will be described below with reference to an enriched submittal data object and schedule-item data objects, but it should be understood that the functionality applies equally to any other pairing of two types of data objects.

As one possible implementation, the search component 308 may utilize a text-based search technique (sometimes referred to as a keyword or full-text search) to search for a candidate set of schedule-item data objects that include words (e.g., in the values for the data fields defined for the schedule-item data objects) that match a set of words included in the search query (e.g., words extracted from the values for the data fields defined for the schedule-item data objects). One representative example of a text-based search technique may comprise a Best Match 25 (bm 25 ) search technique, but other text-based search techniques may be utilized as well.

As another possible implementation, the search component 308 may utilize a semantic search technique that interprets the meaning of the text string to generate search results comprising a candidate set of schedule-item data objects found to be related to the enriched submittal data object. For instance, as one possibility, the search component 308 may utilize an embedding-based semantic search technique (or sometimes referred to as a vector search technique). In this respect, prior to performing the search, each of at least a subset of the schedule-item data objects created for a construction project may be transformed into a respective set of one or more embeddings, which are then stored in one or more data stores for future use (e.g., one or more data stores included in a data storage layer of the back-end computing platform 102). In practice, these sets of embeddings could take the form of document embeddings, sentence embeddings, and/or word embeddings, among other possibilities. In turn, a set of one or more embeddings contained within a search query may be compared against the respective sets of one or more embeddings in the one or more data stores in order to identify a candidate set of schedule-item data objects that are deemed to be related to the enriched submittal data object (e.g., based on a metric that measures vector similarity, such as cosine similarity, Euclidean distance, etc.).

In line with the discussion, the function of transforming a schedule-item data object into a respective set of one or more embeddings may take any of various forms, and in at least some implementations, may involve (i) pre-processing the schedule data object so as to place it into a form that can be input into an embedding model, such as by extracting certain data alphanumeric values from the enriched submittal data object and placing them into an alphanumeric text string and/or preparing an image for input to the embedding model, and then (ii) inputting the pre-processed version of the schedule-item data object (e.g., the alphanumeric text string or the image) into the embedding model that functions to generate the set of one or more embeddings. In this respect, the embedding model that is used to transform the schedule-item data objects into respective sets of one or more embeddings may comprise any one of various types of embedding models that are capable of generating embeddings, such as a pre-trained document, sentence, or word embedding model that may or may not be further trained (e.g., via fine tuning, few-shot learning, or the like), and/or a document, sentence, or word embedding model that is trained in the first instance, among other possibilities. Some representative examples of embedding models include a Doc2Vec, Sentenc2Vec, or Word2Vec type of embedding model, a GloVe type of embedding model, an ElMo type of embedding model, a fastText type of embedding model, and a BERT type of embedding model, among others. It should be understood, however, that the embedding model that is used to transform the schedule-item data objects into respective sets of embeddings may take various other forms as well.

As another possibility, the search component 308 may utilize a different type of semantic search technique, examples of which may include query classification, semantic query parsing, and/or knowledge graphs, among other possibilities.

As yet another possible implementation, the search component 308 may utilize both a text-based search technique and a semantic search technique (e.g., an embedding-based semantic search technique) to search for a candidate set of schedule-item data objects that are related to the enriched submittal data object, which may be referred to as a “hybrid search.”

After searching for the candidate set of schedule-item data objects that are deemed to be related to the enriched submittal data object, the search component 308 may generate search results comprising an identification of the candidate set of schedule-item data objects and then return the search results to component from which the one or more search queries were received (e.g. the schedule item identification agent 306 or the generative AI model 310). In this respect, the identification of the candidate set of schedule-item data objects may take any of various forms. For instance, as one possibility, the identification of the candidate set of schedule-item data objects may comprise respective values for any of various data fields contained within schedule-item data objects found in the candidate set of schedule-item data objects, examples of which may include names (e.g., titles) of the schedule-item data objects, descriptions of the schedule-item data objects, start, end, and/or due dates of the schedule-item data objects (if applicable), and/or other values that are extracted from or otherwise derived based on the candidate set of schedule-item data objects, among other possible examples. As another possibility, the identification of the candidate set of schedule-item data objects may comprise identifiers of the candidate set of schedule-item data objects, in which case the schedule item identification agent 306 may then function to utilize the identifiers to retrieve the data values of the data objects that are to be included in the prompt for the generative AI model 310. The identification of the candidate set of schedule-item data objects may take other forms as well.

The search component 308 may perform other functions as well.

Turning next to the generative AI model 310, in line with the discussion above, the generative AI model 310 may generally function to (i) receive a prompt comprising a request to perform a task, (ii) perform the task, (iii) generate a response to the request that indicates the results of performing the task, and (iv) return the response to the agent that sent the prompt comprising the request (e.g., which, as mentioned above, may be the schedule item identification agent 306).

For instance, as discussed above, the generative AI model 310 may receive a prompt from the schedule item identification agent 306 comprising a request to determine which schedule-item data objects are related to an enriched submittal data object, in which case the generative AI model 310 may then function to predict which schedule-item data objects are related to the enriched submittal data object, generate a response comprising the prediction of which schedule-item data objects are related to the enriched submittal data object, and return the response to the schedule item identification agent 306.

The generative AI model 310 may receive various other types of requests and perform various other tasks as well.

The generative AI model 310 may take any of various forms. For instance, the generative AI model 310 may be a transformer-based model (e.g., a language model such as a large language model (LLM) and/or a multimodal model such as a vision-language model (VML)), a diffusion model, a model based on a generational adversarial network (GAN), and/or a model based on a variational autoencoders (VAEs), among other possible types of generative AI models. Further, the generative AI model 310 may comprise a pre-trained generative AI model (e.g., an “off-the-shelf” generative AI model) that may or may not be further trained (e.g., via fine tuning, few-shot learning, or the like), or may comprise a generative AI model that is trained in the first instance to perform the tasks described herein, among other possibilities. Some representative examples of pre-trained generative AI models include a generative pre-trained transformer (GPT) type of generative AI model, a bidirectional encoder representations from transformers (BERT) type of generative AI model, a bidirectional auto-regressive transformer (BART) type of generative AI model, a text-to-text transfer transformer (T5) type of generative AI model, a pre-training with extracted gap sentences for abstractive summarization (PEGASUS) type of generative AI model, a large language model meta AI (LlaMA) type of generative AI model, a Phi-2 or Phi-3 type of generative AI model, a PaliGemma type of generative AI model, and/or a Florence-2 type of generative AI model, among other examples. The generative AI model 310 may take other forms as well.

It should also be understood that the components of the example software-based pipeline 300 could interface with multiple different generative AI models 310. For instance, as one possibility, different components of the example software-based pipeline 300 could be configured to interface with multiple different generative AI models 310, which could be of the same type or of different types. As another possibility, a given component of the example software-based pipeline 300 (e.g., the schedule item identification agent 306) could be configured to interface with multiple different generative AI models 310, which could be of the same type or of different types. Other configurations are possible as well.

Turning next to the submittal and schedule linking agent 312, the final set of schedule-item data objects that are determined to be related to the given submittal data object may be received from the schedule item identification agent 306 as discussed above. At a high-level, the submittal and schedule linking agent 312 may generally function to (i) cause a client device to display (e.g., via the submittals tool of the construction management software application) an indication of the final set of schedule-item data objects and (ii) generate a respective dynamic link between the given submittal data object and one or more schedule-item data objects in the final set of schedule-item data objects.

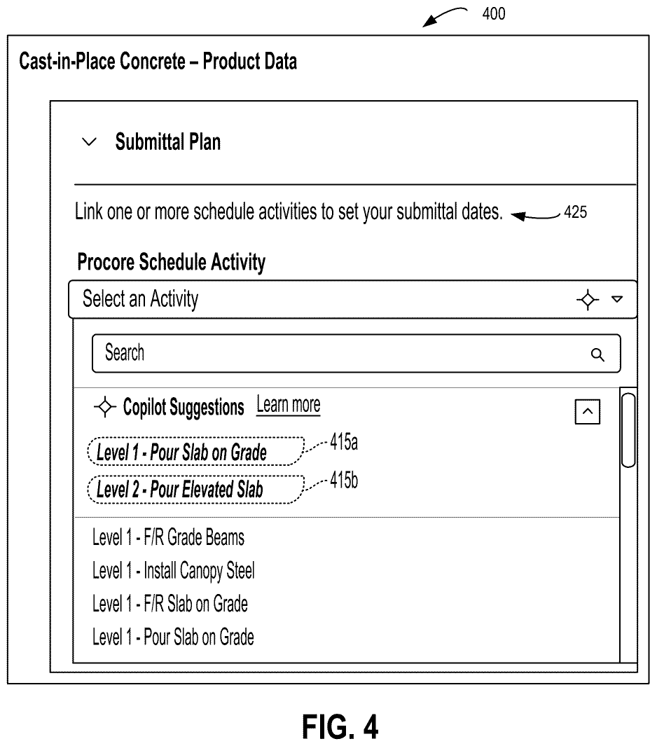

The submittal and schedule linking agent 312 may cause a client device, such as one of the client devices 104 depicted in FIG. 1, to display an indication of the final set of schedule-item data objects in various forms. One possible example is shown in FIG. 4, which depicts a GUI view 400 of a submittal data object named “Cast-in-Place Concrete—Product Data” that may be displayed via the submittals tool of the construction management software application. For example, FIG. 4 may represent a GUI view that is displayed to a user of client device 104a as the user is interacting with the submittals tool. In particular, the user may have just created a new submittal data object and is now editing the submittal data object to add additional information. In this regard, the initial creation of the submittal data object shown in FIG. 4 may have been a trigger that initiated the software-based pipeline 300 discussed above, as information indicating the submittal data object (e.g., a name, an activity code, etc.) was received by the front-end interface 302 from the client device 104a, passed to the data enrichment agent 304, and so on.

In some ways, the GUI view 400 may be similar to the GUI view 230 shown in FIG. 2C, in that a user can select a schedule-item data object corresponding to a schedule activity from a drop-down menu. However, numerous improvements over the functionality discussed above with respect to FIG. 2C can be seen in FIG. 4. As one example, the GUI view 400 includes a selectable indications 415a and 415b of the final set of schedule-item data objects that were determined via the software-based pipeline 300 discussed above. In particular, selectable indications of the schedule-item data objects “Level 1—Pour Slab on Grade” and “Level 2—Pour Elevated Slab” are presented as AI-generated suggestions at the top of the drop-down list of schedule activities. In this way, a user may select one or both of the selectable indications to link the respective schedule-item data objects to the submittal data object, which provides an additional improvement over the GUI view shown in FIG. 2C, which was limited to identification of a single schedule-item data object.

Further, the GUI view 400 illustrates one possibility in which the names of related schedule-item data objects are listed for selection, however other examples are also possible in which further information is displayed to assist a user in making a selection. For example, the drop-down list shown in FIG. 4 may additionally include corresponding start dates for each displayed schedule-item data object and/or a confidence score output by the generative AI model 310 for each displayed schedule-item data object. Other information corresponding to each schedule-item data object may also be displayed.

Moreover, the user might select still further schedule-item data objects to be linked with the submittal data object shown in the GUI view 400. For instance, the user might scroll through the drop-down list to find a particular schedule-item data objects or use the search feature depicted in FIG. 4. Still further, the final set of schedule-item data objects that were determined via the software-based pipeline 300 may have included more than the two data objects that are shown in as suggestions in FIG. 4. In this regard, the two suggestions may have been selected for display because their determined relationship to the submittal data objects had highest confidence level, or because the submittal and schedule linking agent 312 and/or the submittals tool 314 limits the initial display of suggested data objects to two, among other possibilities. As the user selects one or both of the selectable indications 415a or 415b to link the suggested schedule-item data objects to the submittal data object, they may be replaced with additional schedule-item data objects from the final set (e.g., the schedule-item data object with the next highest confidence level, etc.).

Based on the selections of the one or more schedule-item data objects as generally shown in FIG. 4, the submittal and schedule linking agent 312 may generate dynamic links between the submittal data object and the selected schedule-item data objects in various ways. As one example, the submittal and schedule linking agent 312 may update (e.g., via an API of the submittals tool 314) the submittal data object to include a pointer or similar reference to each of the schedule-item data objects (e.g., by updating a data field of the submittal data object). The pointer may encode a specific relationship between data fields of the submittal data object and each schedule-item data object that defines the type of dynamic interdependency that exists between the two data objects. For example, a given pointer may encode a relationship between the due date of the submittal data object (e.g., the date the submittal is approved) and the start date of a given schedule-item data object. The relationship may dictate that the due date of the submittal data object can be no fewer than 7 days before the start date of the given schedule-item data object, among other possibilities. This, in turn, may allow for dynamic notifications and/or updates to be automatically generated based on changes to the given schedule-item data object (e.g., a change to the start date) that affect the relationship encoded by the pointer, as discussed in further detail below.

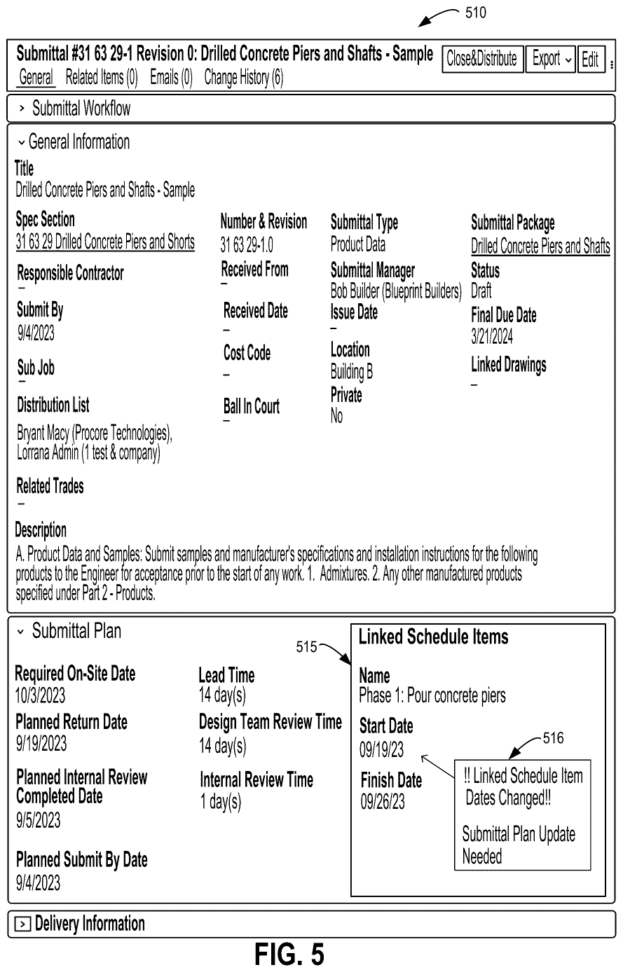

In some implementations, a visual indication of a given schedule-item data object that has been linked to a submittal data object may be viewable within the submittals tool. One example of such a visualization is depicted in FIG. 5, which includes an example GUI view 510 of a submittals tool 314. In this regard, the GUI view 510 may be similar to the GUI view 210 shown in FIG. 2B, which displays information for a selected submittal data object entitled “Drilled Concrete Piers and Shafts-Sample.” However, the GUI view 510 of FIG. 5 additionally includes a visual representation, shown in a linked schedule items pane 515, of a schedule-item data object that has been linked to the submittal data object using the software-based pipeline 300 discussed above. In FIG. 5, the linked schedule items pane 515 displays information from data fields of the linked schedule-item data object, including its name, and its start and finish dates. Other information from data fields of the linked schedule-item data object may be displayed as well. In addition, if multiple schedule-item data objects were linked to the submittal data object, the linked schedule items pane 515 may display a visual representation of each of them (e.g., in a list, viewable via a scroll bar, etc.).

In addition, dynamic schedule information related to the linked schedule-item data object may also be displayed within the submittals tool. For instance, if the linked schedule-item data object is changed in such a way that impacts the submittal data object, this impact may be detected (e.g., by the submittals tool 314 and/or the schedule tool 316) based on the interdependency encoded by the dynamic link between the data objects. The dynamic schedule information displayed within the submittals tool may take various forms. One possible example of this type of dynamic information is shown in FIG. 5 in the form of a visual notification 516 that is included within the linked schedule items pane 515. The notification 516 indicates that the start and finish dates of the linked schedule-item data object have changed, and that based on this change to the schedule-item data object, an update is needed to the submittal plan (i.e., dates in the submittal plan). For example, the schedule-item data object may have been pulled forward in time to an earlier start date. As a result, the due date of the submittal data object may not satisfy the encoded relationship to the start date discussed above.

In some implementations, the notification 516 may be selectable to initiate the necessary update to the submittal plan. The initiation of updates to the submittal data object via selection of the notification 516 may take various forms. As one possibility, selecting the notification 516 may open dialog box within the GUI view 510 for editing the corresponding dates of the submittal data object that need to be updated. In this regard, the notification 516 may persist until updated submittal dates are entered that satisfy the encoded relationship between the due date of the submittal data object and the start date of the schedule-item data object. As another possibility, the notification 516 may include a suggestion for new dates to be applied to the submittal data object, which may be calculated by the submittals tool 314 based on the encoded relationship. Selecting the notification 516 may confirm the suggested dates and update the submittal data object accordingly. Selecting the notification 516 to update the submittal data object may take other forms as well.

In still further implementations, it is possible that in addition to determining updated date suggestions to be applied the submittal data object based on the change to the linked schedule-item data object, the submittals tool 314 may implement the updated date suggestions automatically. In this scenario, the notification 516 may still be presented as a way to alert the user to the change in the submittal data object. As above, a notification of this type may be presented to a user in various different ways, within the submittals tool 314 of the construction management software application or elsewhere.

The notification 516 may additionally or alternatively be displayed in other ways, and on other GUI views within the submittals tool 314. Further, the dynamic schedule information related to linked schedule-item data objects may take various other forms as well.

In view of this above, it will be appreciated that linking one or more schedule-item data objects to a submittal data object may provide the basis to initially establish dates for a submittal plan at the time of creation of the submittal data object. This improved functionality is evident in the GUI view 400 of FIG. 4, which includes a textual indication 425 that linking schedule-item data objects in the GUI view 400 will set the dates for the submittal data object that is being edited. In this regard, the dates for the submittal data object may be set (e.g., automatically set) based on one or more linked schedule-item data objects in various ways. As noted above, each schedule-item data object within the construction management software application will generally include a data field with a value that indicates its start date, among other information. The submittals tool 314 may determine the earliest start date from among the linked schedule-item data objects and set a due date for the submittal data object that is a predetermined period of time before the earliest start date. In some implementations, this may be the minimum period of time encoded by the dynamic link between the two data objects (e.g., 7 days). In other implementations, an additional period of time (e.g., 7 additional days) may be added to provide some margin for delay in the submittal without delaying the earliest schedule-item data object. Once the due date for the submittal data object is set, preceding dates in the submittal plan may be set accordingly, based on standard lead times that may be applied by the submittals tool 314.

Due dates for the submittal data object may be set based on one or more linked schedule-item data objects in other ways as well.

As discussed above, the submittal and schedule linking agent 312 may update the submittal data object to include a pointer to each of the selected schedule-item data objects as part of generating the dynamic links between data objects. Yet this may only establish the dynamic link on one direction, in which changes to schedule-item data objects are dynamically recognized by the submittals tool 314. To establish the dynamic link in both directions, the submittal and schedule linking agent 312 may additionally update (e.g., via an API of the schedule tool 316) each of the selected schedule-item data objects to include a pointer to the submittal data object (e.g., by updating a data field of each schedule-item data object).

As described above, the pointer for a given schedule-item data object may encode a specific relationship between data fields of the schedule-item data object and the linked submittal data object that defines the type of dynamic interdependency that exists between the two data objects, such as the minimum allowable time before a schedule-item data object's start date that the submittal object's due date may be set. This, in turn, may allow for dynamic notifications and/or updates to be automatically generated based on changes to the submittal item (e.g., a change to the due date) that may affect the relationship encoded by the pointer.

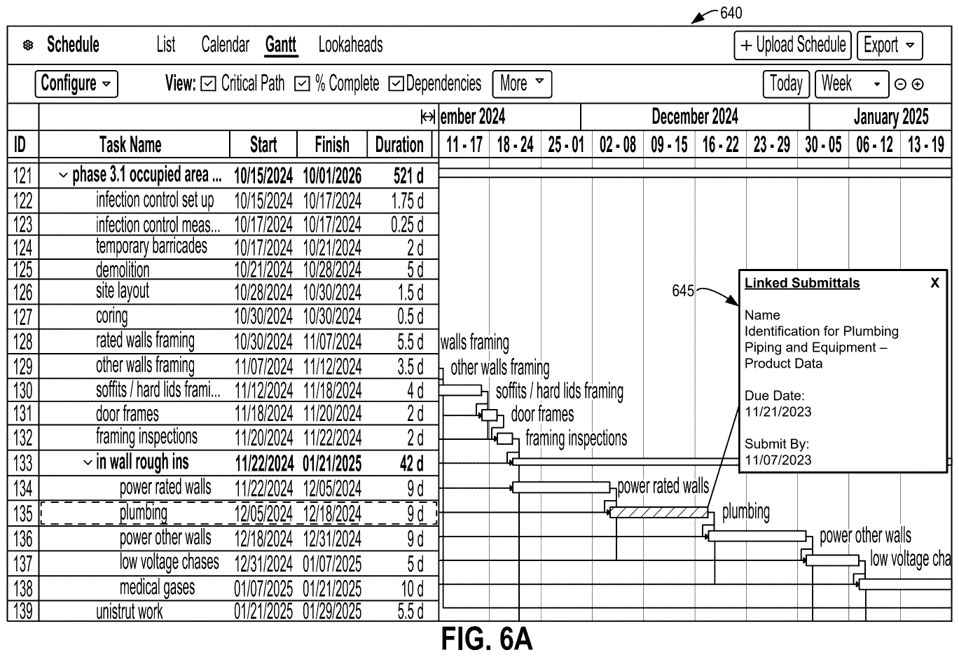

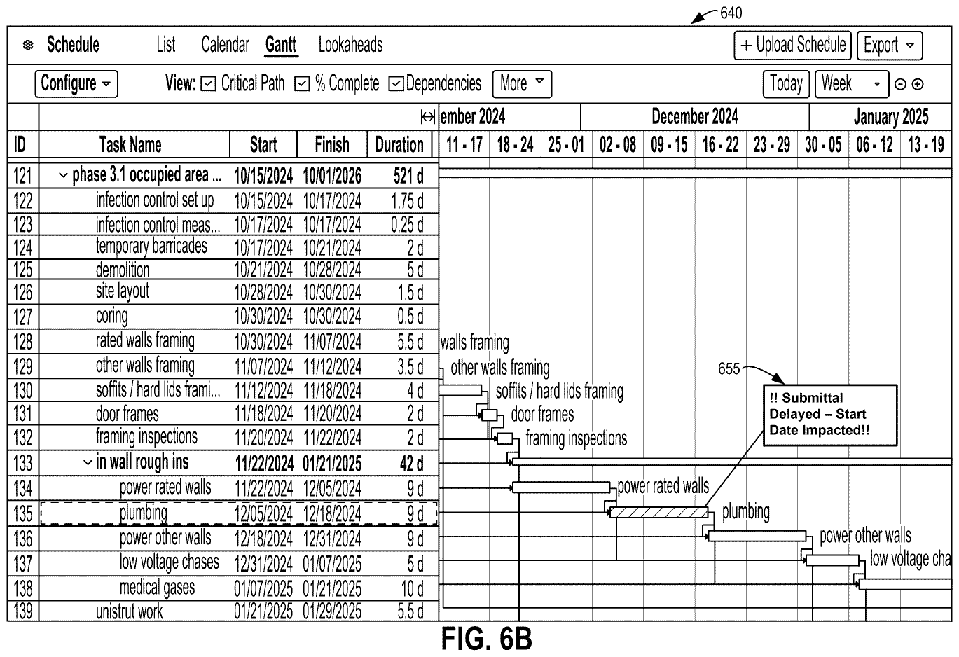

In some implementations, a visual indication of a submittal data object that has been linked to a given schedule-item data object may be viewable within the schedule tool. One example of such a visualization is depicted in FIG. 6A, which includes an example GUI view 640 of the schedule tool 316. In this regard, the GUI view 640 may be similar to the GUI view 240 shown in FIG. 2D, which displays a typical Gantt chart. However, the GUI view 640 of FIG. 6A additionally includes a visual representation, shown in a pop up window 645, of a submittal data object with the name “Identification for Plumbing Piping and Equipment—Product Data” that has been linked to the “plumbing’ schedule-item data object using the software-based pipeline 300 discussed above. In FIG. 6A, the pop up window 645 displays information from data fields of the linked submittal data object, including its name, its due date, and its submit by date. Other information from data fields of the linked submittal data object may be displayed as well. In addition, if multiple submittal data objects have been linked to the schedule-item data object, the pop up window 645 may display a visual representation of each of them (e.g., in a list, viewable via a scroll bar, etc.).

In addition, dynamic schedule information related to the linked submittal data object may also be displayed within the schedule tool 316. For instance, if the linked submittal data object is changed in such a way that impacts the schedule-item data object, this impact may be detected (e.g., by the submittals tool 314 and/or the schedule tool 316) based on the interdependency encoded by the dynamic link between the data objects. In this regard, the back-end computing platform 102 that carries out the software-based pipeline 300 discussed herein may be configured to analyze and identify potential risks in the schedule that may result in schedule delays or other similar problems.

In some implementations, risks may be automatically identified if a due date for completion of a given submittal data object has passed without the submittal data object being marked as complete. As another possibility, potential risks to the schedule may be analyzed by simulating possible delays that might occur in one or more data objects (e.g., submittal data objects) that have dependent schedule-item data objects. For instance, the back-end computing platform 102 may include a software tool that carries out a plurality of simulations (e.g., Monte Carlo simulations) to determine the potential effects of a delay to some or all of the submittal data objects within the construction management software application. In doing so, the back-end computing platform 102 may determine that not all delays have equivalent consequences, and in some delays have more severe and/or more extensive downstream effects than others. As a result, the back-end computing platform 102 may determine a corresponding severity score for any potential or actual risks that are identified and may display such severity scores to users. In this way, users may beneficially prioritize certain more impactful submittals over others when trying to avoid or mitigate schedule delays.

The dynamic submittals information displayed within the schedule tool 316 may take various forms. One possible example of this type of dynamic information is shown in FIG. 6B in the form of a visual notification 655 that takes the form of a pop up window within the Gantt chart shown in the GUI view 640. The notification 655 indicates that a submittal data object linked to the “plumbing” schedule-item data object is delayed, and that based on the delay, the start date of the “plumbing” schedule-item data object is impacted. For example, approval of the linked submittal depicted in FIG. 6A may be taking longer than expected such that it will not be approved by the originally planned due date for the submittal data object. As a result, the “plumbing” schedule activity cannot commence on time, and thus the start date of the schedule-item data object has been impacted and will need to be updated to move it later in time.

In some implementations, the notification 655 may be selectable to initiate the necessary update to the schedule. The initiation of updates to the schedule-item data object via selection of the notification 655 may take various forms. As one possibility, selecting the notification 655 may open a dialog box within the GUI view 640, or a new GUI view entirely, for editing the corresponding start date of the schedule-item data object. In this regard, the notification 655 may persist until an updated start date is entered that satisfies the encoded relationship between the due date of the submittal data object (e.g., the changed due date reflecting the delay) and the start date of the schedule-item data object. As another possibility, the notification 655 may include a suggestion for a new start date to be applied to the schedule-item data object, which may be calculated by the schedule tool 316 based on the encoded relationship. In this regard, the generative AI model 310 may be utilized to suggest updated start dates that reduce identified risks in the schedule. Selecting the notification 655 may confirm the suggested start date and update the schedule-item data object (e.g., and dependent schedule items) accordingly. Selecting the notification 655 to update the schedule-item data object may take other forms as well.

Consistent with the discussion above, the generative AI model 310 may generate suggested updates to the schedule by taking into account the particular relationships between conflicting data objects (e.g., submittal data objects and schedule-item data objects) and the relative impact of changes to such data objects. As noted above, the dynamic links between submittal data objects and schedule-item data objects submittals may have a many-to-many arrangement, and some links may be determined to be more important than others. For example, some submittal and/or schedule-items data objects may have differing impacts based on material lead times, the sequencing of when certain materials are needed at the construction site, the timing of when certain activities or tasks need to start. Further, in some implementations, a given activity or task may be scheduled to start later, but certain risks such as weather, equipment availability, and/or material price changes risks may indicate a future risk that may be mitigated by starting the activity or task earlier than scheduled. Various other examples are also possible.

In still further implementations, it is possible that in addition to determining an updated start date suggestion to be applied the schedule-item data object based on the change to the linked submittal data object, the schedule tool 316 may implement the updated start date suggestion automatically. In this scenario, the notification 655 may still be presented as a way to alert the user to the change in the schedule-item data object. As above, a notification of this type may be presented to a user in various different ways, within the schedule tool 316 of the construction management software application or elsewhere.

The notification 655 may additionally or alternatively be displayed in other ways, and on other GUI views within the schedule tool 316. Further, the dynamic submittal information related to linked submittal data objects may take various other forms as well.

The submittal and schedule linking agent 312 may generate the dynamic links between data objects discussed above as part of the software-based pipeline 300 in other ways as well. For example, as an alternative to updating the submittal data object and selected schedule-item data objects to include pointers to each other for each schedule-item data object that is dynamically linked to a submittal data object, the submittal and schedule linking agent 312 may add an entry to a link table each time a schedule-item data object is dynamically linked to a submittal data object. The entry may represent the linked relationship between the submittal data object and each selected schedule-item data object, and may encode relationship between data fields of the submittal data object and each schedule-item data object that defines the type of dynamic interdependency that exists between the two data objects, such as the dependency between dates discussed above. In this regard the link table may be generated by the submittal and schedule linking agent 312 and may take various forms. For example, the link table may be any of various types of retrieval structures (e.g., a database, a hash table, etc.) that includes a single entry for each submittal data object that maps to the selected set of schedule-item data objects that were linked to the submittal data object. In this regard, the link table may store a “one to many” representation between submittal data objects and schedule-item data objects. In practice, a given schedule-item data object may be repeated in the link table multiple times, if it is linked with multiple different submittal data objects.

Once created, the submittals tool 314 may reference the link table (e.g., via an API) whenever a given submittal data object is changed in a way (e.g., changed to adjust a due date) that might impact any of the schedule-item data objects that are listed in the given submittal data object's entry in the link table. If the change to the given submittal data object impacts one or more of the schedule-item data objects, one or more notifications may be generated as discussed above, along with suggested or automatic updates to start dates of the impacted schedule-item data objects.

Similarly, the schedule tool 316 may reference the link table (e.g., via an API) whenever a given schedule-item data object is changed in a way (e.g., changed to adjust a start date) that might impact any of the submittal data objects whose link table entries include the given schedule-item data object. If the change to the given schedule-item data object impacts one or more of the submittal data objects, one or more notifications may be generated as discussed above, along with suggested or automatic updates to due dates of the impacted submittal data objects.

In the foregoing discussion, the generation of dynamic links between submittal data objects and schedule-item data objects by the submittal and schedule linking agent 312 was initiated by a user selection of one or move schedule-item data objects that were determined to be related to the submittal data object via the software-based pipeline 300. However, it is also contemplated that in some implementations, the final set of schedule-item data objects determined to be related to the submittal data object will be automatically selected and that the dynamic links between them will be automatically generated. This, in turn, may also serve to automatically generate dates (e.g., due dates) for each submittal data object that is created in the construction management software application.

Still further, although the software-based pipeline 300 shown in FIG. 3 and discussed above is generally directed to identifying schedule-item data objects that are related to a given submittal data object and generating dynamic links corresponding to each identified relationship, it should be understood that a similar pipeline may be used to generate the same dynamic links by starting from a given schedule item data object and identifying related submittal data objects. For example, the contents of a given schedule-item data object (e.g., the activity description, listed resources, etc.) may be analyzed and compared with the dataset of tokens (e.g., keywords, phrases, index terms, and/or numbers) discussed above to suggest or automatically assign a construction activity code to the given schedule-item data object. The activity code may then be used as one of the data values in a text-based search query that is generated by a submittal item identification agent (e.g., analogous to the schedule item identification agent 306) and transmitted to a search component (e.g., the search component 308). Results from the search query may be included in a prompt that is passed to the generative AI model 310, as generally discussed above, ultimately resulting in dynamic links being generated between the given schedule-item data object and one or more schedule item data objects determined to be related to the given schedule-item data object.

Still further, as will be appreciated from the foregoing examples, a similar software-based pipeline may be configured to identify relationships between other types of data objects within a construction management software application as well, including requests for information (RFIs), change orders, inspections, observations, daily logs, etc.

The example software-based pipeline 300 may take various other forms in addition to those described above. For instance, as one possibility, the example software-based pipeline 300 may include other components that are not shown or described above but may nevertheless facilitate the functionality disclosed herein. As another possibility, certain of the components shown and described above could be combined together or separated out into multiple sub-components. For example, in an implementation where one or more of the submittal data enrichment agent 304, the schedule item identification agent 306, and the submittal and schedule linking agent 312 are implemented in the form of configuration files that are executed by a centralized execution engine, the centralized execution engine could be combined together into a single component. As another example, the front-end interface 302 could be combined together with the submittal data enrichment agent 304. As yet another example, some or all of the operations discussed above as being carried out by the submittal and schedule linking agent 312 may instead be carried out by one or both of the schedule item identification agent 306 and/or the submittals tool 314 (or the schedule tool 316, as appropriate). Other examples are possible as well. As yet another possibility, certain of the components shown and described above may perform additional or different functionality from what is described above. Other variations of the example software-based pipeline 300 are possible as well.

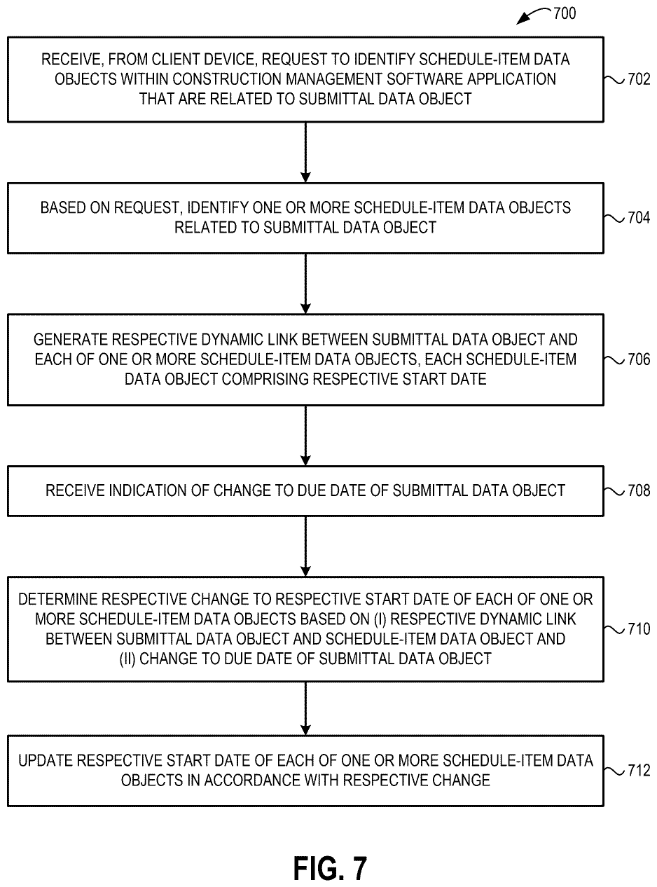

Turning next to FIG. 7, a flow diagram is shown to illustrate one possible implementation of the functionality that may be carried out by the example software-based pipeline 300 of FIG. 3. For purposes of illustration, the example functionality 700 of FIG. 7 is described as being carried out by the back-end computing platform 102 of FIG. 1, but it should be understood that the example functionality 700 of FIG. 7 may be carried out by any computing platform that is capable of running the software disclosed herein. Further, it should be understood that the example functionality of FIG. 7 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular example.

As shown in FIG. 7, the example functionality 700 may begin at block 702 with the back-end computing platform 102 receiving, from a client device, a request to identify schedule-item data objects within a construction management software application that are related to a submittal data object. For example, the client device may be one of the client devices 104 shown in FIG. 1. The request to identify schedule-item data objects may take various forms, as generally discussed above with respect to the software-based pipeline 300.

At block 704, the back-end computing platform 102 may, based on the request, identify one or more schedule-item data objects related to the submittal data object. The one or more schedule-item data objects may be identified in various ways, involving one or more of the AI agents depicted in FIG. 3 and described above.

At block 706, the back-end computing platform 102 may generate a respective dynamic link between the submittal data object and each of the one or more schedule-item data objects, each schedule-item data object comprising a respective start date. As discussed above, the respective dynamic links between the submittal data object and each of the one or more schedule-item data objects may take various forms, including a pointer and/or an entry in a link table, among other possibilities.

At block 708, the back-end computing platform 102 may receive an indication of a change to a due date of the submittal data object. As discussed above with respect to FIGS. 6A and 6B, the change to the due date of the submittal data object (e.g., delaying the due date) may be displayed via a schedule tool of the construction management software application, in association with one or more schedule-item data objects that are affected by the change.

At block 710, the back-end computing platform 102 may determine a respective change to the respective start date of each of the one or more schedule-item data objects based on (i) the respective dynamic link between the submittal data object and the schedule-item data object and (ii) the change to the due date of the submittal data object. As noted above, the back-end computing platform 102 may determine the respective changes in various ways, including by generating automated suggestions for updates to the one or more schedule-item data objects, among other possibilities.

At block 712, the back-end computing platform 102 may update the respective start date of each of the one or more schedule-item data objects in accordance with the respective change. Consistent with the discussion above, such updates may be implemented based on user input or automatically, or combinations of both.

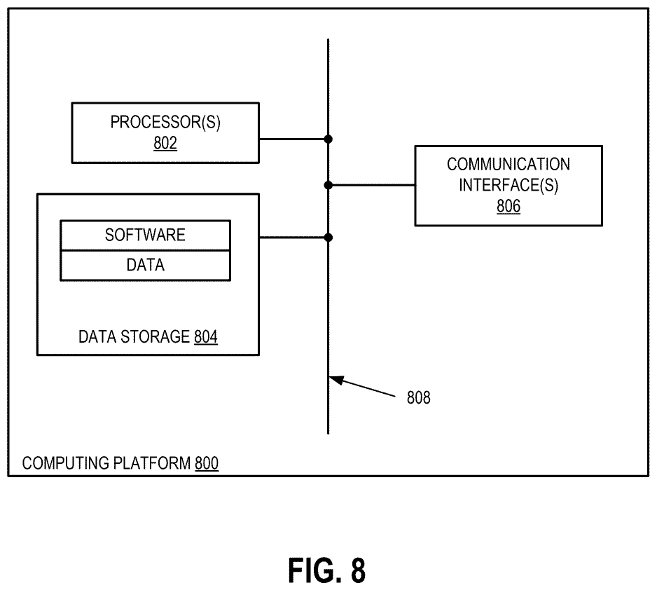

Turning now to FIG. 8, a simplified block diagram is provided to illustrate some structural components that may be included in an example computing platform 800 that may be configured to perform the platform-side functions disclosed herein. At a high level, the example computing platform 800 may generally comprise any one or more computer systems (e.g., one or more servers) that collectively include one or more processors 802, data storage 804, and one or more communication interfaces 806, each of which may be communicatively linked by a communication link 808 that may take the form of a system bus, a communication network such as a public, private, or hybrid cloud, or some other connection mechanism. Each of these components may take various forms.

For instance, the one or more processors 802 may comprise one or more processor components, such as one or more central processing units (CPUs), graphics processing units (GPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 802 could comprise processing components that are distributed across a plurality of physical computing devices connected via a network, such as a computing cluster of a public, private, or hybrid cloud.

In turn, the data storage 804 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 804 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 8, the data storage 804 may be capable of storing both (i) program instructions that are executable by the one or more processors 802 such that the example computing platform 800 is configured to perform any of the various functions disclosed herein (including but not limited to any of the server-side functions discussed above), and (ii) data that may be received, derived, or otherwise stored by the example computing platform 800.

The one or more communication interfaces 806 may comprise one or more interfaces that facilitate communication between the example computing platform 800 and other systems or devices, where each such interface may be wired and/or wireless and may communicate according to any of various communication protocols. As examples, the one or more communication interfaces 806 may take include an Ethernet interface, a serial bus interface (e.g., Firewire, USB (Universal Serial Bus) 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the example computing platform 800 may additionally have an Input/Output (I/O) interface that includes or provides connectivity to I/O components that facilitate user interaction with the example computing platform 800, such as a keyboard, a mouse, a trackpad, a display screen, a touch-sensitive interface, a stylus, a virtual-reality headset, and/or one or more speaker components, among other possibilities.

It should be understood that the example computing platform 800 is one example of a computing platform that may be used with the examples described herein. Numerous other arrangements are possible and contemplated herein. For instance, in other examples, the example computing platform 800 may include additional components not pictured and/or more or less of the pictured components.

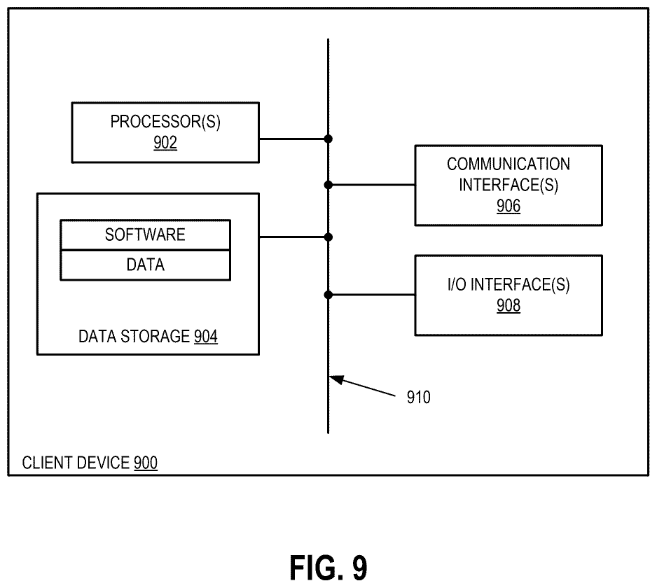

Turning next to FIG. 9, a simplified block diagram is provided to illustrate some structural components that may be included in an example client device 900 that may be configured to perform some the client-side functions disclosed herein. At a high level, the example client device 900 may include one or more processors 902, data storage 904, one or more communication interfaces 906, and an I/O interface 908, each of which may be communicatively linked by a communication link 910 that may take the form a system bus and/or some other connection mechanism. Each of these components may take various forms.

For instance, the one or more processors 902 of the example client device 900 may comprise one or more processor components, such as one or more CPUs, GPUs, ASICs, DSPs, and/or programmable logic devices such as FPGAs, among other possible types of processing components.

In turn, the data storage 904 of the example client device 900 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 9, the data storage 904 may be capable of storing both (i) program instructions that are executable by the one or more processors 902 of the example client device 900 such that the example client device 900 is configured to perform any of the various functions disclosed herein (including but not limited to any of the client-side functions discussed above), and (ii) data that may be received, derived, or otherwise stored by the example client device 900.

The one or more communication interfaces 906 may comprise one or more interfaces that facilitate communication between the example client device 900 and other systems or devices, where each such interface may be wired and/or wireless and may communicate according to any of various communication protocols. As examples, the one or more communication interfaces 906 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 908 may generally take the form of (i) one or more input interfaces that are configured to receive and/or capture information at the example client device 900 and (ii) one or more output interfaces that are configured to output information from the example client device 900 (e.g., for presentation to a given user). In this respect, the one or more input interfaces of I/O interface may include or provide connectivity to input components such as a microphone, a camera, a keyboard, a mouse, a trackpad, a touchscreen, an accelerometer, a gyroscope, a location signal receiver (e.g., a cellular signal receiver, a Wi-Fi Positioning System (WPS) receiver, a Bluetooth receiver, a Radio Frequency Identification (RFID) receiver, an Ultra-Wideband (UWB) receiver, a magnetic field receiver, a satellite signal receiver such as a GPS, etc.), and/or a stylus, among other possibilities, and the one or more output interfaces of the I/O interface 908 may include or provide connectivity to output components such as a display screen and/or an audio speaker, among other possibilities.

It should be understood that the example client device 900 is one example of a client device that may be used with the examples described herein. Numerous other arrangements are possible and contemplated herein. For instance, in other examples, the example client device 900 may include additional components not pictured and/or more or fewer of the pictured components.

### IV. CONCLUSION

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

What is claimed is:

1. A computing platform comprising:
at least one processor;
at least one non-transitory computer-readable medium; and
program instructions stored on the at least one non-transitory computer-readable medium that, when executed by the at least one processor, cause the computing platform to:
receive, from a client device, a request to identify schedule-item data objects within a construction management software application that are related to a submittal data object;
based on the request, identify one or more schedule-item data objects related to the submittal data object;
generate a respective dynamic link between the submittal data object and each of the one or more schedule-item data objects, each schedule-item data object comprising a respective start date;
receive an indication of a change to a due date of the submittal data object;
determine a respective change to the respective start date of each of the one or more schedule-item data objects based on (i) the respective dynamic link between the submittal data object and the schedule-item data object and (ii) the change to the due date of the submittal data object; and
update the respective start date of each of the one or more schedule-item data objects in accordance with the respective change.

2. The computing platform of claim 1, wherein the program instructions that, when executed by the at least one processor, cause the computing platform to generate the respective dynamic link between the submittal data object and each of the one or more schedule-item data objects comprise instructions that, when executed by the at least one processor, cause the computing platform to:
add, to the submittal data object, a respective pointer to each of the one or more schedule-item data objects.

3. The computing platform of claim 1, wherein the program instructions that, when executed by the at least one processor, cause the computing platform to generate the respective dynamic link between the submittal data object and each of the one or more schedule-item data objects comprise instructions that, when executed by the at least one processor, cause the computing platform to:
add, to each of the one or more schedule-item data objects, a respective pointer to the submittal data object.

4. The computing platform of claim 1, wherein the program instructions that, when executed by the at least one processor, cause the computing platform to generate the respective dynamic link between the submittal data object and each of the one or more schedule-item data objects comprise instructions that, when executed by the at least one processor, cause the computing platform to:
generate, for each of the one or more schedule-item data objects, a respective entry to a link table to represent the respective dynamic link between the submittal data object and the one or more schedule-item data objects.

5. The computing platform of claim 1, further comprising program instructions stored on the at least one non-transitory computer-readable medium that, when executed by the at least one processor, cause the computing platform to:
after identifying the one or more schedule-item data objects, cause the client device to display a respective selectable indication for each of the one or more schedule-item data objects; and
receive, from the client device, information indicating a user selection of at least one of the one or more schedule-item data objects to be linked to the submittal data object.

6. The computing platform of claim 1, further comprising program instructions stored on the at least one non-transitory computer-readable medium that, when executed by the at least one processor, cause the computing platform to:
before receiving the indication of the change to the due date of the submittal data object, determine, based on the respective start dates of the one or more schedule-item data objects, the due date of the submittal data object; and
update the submittal data object to include the determined due date of the submittal data object.

7. The computing platform of claim 1, further comprising program instructions stored on the at least one non-transitory computer-readable medium that, when executed by the at least one processor, cause the computing platform to:
cause the client device to display a respective indication of the determined respective change to the respective start date of each of the one or more schedule-item data objects.

8. The computing platform of claim 7, wherein the program instructions that, when executed by the at least one processor, cause the client device to update the respective start date of each of the one or more schedule-item data objects in accordance with the respective change comprise instructions that, when executed by the at least one processor, cause the computing platform to:
cause the client device to display a respective selectable indication of the determined respective change to the respective start date of each of the one or more schedule-item data objects; and
receive, from the client device, information indicating a user confirmation of the respective indication of the determined respective change to the respective start date of at least one of the one or more schedule-item data objects.

9. The computing platform of claim 1, wherein the program instructions that, when executed by the at least one processor, cause the computing platform to identify schedule-item data objects related to the submittal data object comprise instructions that, when executed by the at least one processor, cause the computing platform to:
generate a search query that seeks to identify a candidate set of schedule-item data objects that are related to the submittal data object;
perform a search in accordance with the search query to identify the candidate set of schedule-item data objects;
generate a prompt for a generative AI model that comprises a request to determine which of the candidate set of schedule-item data objects are related to the submittal data object;
pass the prompt to the generative AI model;
receive, from the generative AI model, a prediction of which of the candidate set of schedule-item data objects are related to the submittal data object based on the prompt; and
based on the prediction, determine a final set of schedule item data objects that are related to the submittal data object, wherein the final set comprises the one or more schedule-item data objects.

10. A non-transitory computer-readable medium, wherein the non-transitory computer-readable medium is provisioned with program instructions that, when executed by at least one processor, cause a computing platform to:
receive, from a client device, a request to identify schedule-item data objects within a construction management software application that are related to a submittal data object;
based on the request, identify one or more schedule-item data objects related to the submittal data object;
generate a respective dynamic link between the submittal data object and each of the one or more schedule-item data objects, each schedule-item data object comprising a respective start date;
receive an indication of a change to a due date of the submittal data object;
determine a respective change to the respective start date of each of the one or more schedule-item data objects based on (i) the respective dynamic link between the submittal data object and the schedule-item data object and (ii) the change to the due date of the submittal data object; and
update the respective start date of each of the one or more schedule-item data objects in accordance with the respective change.

11. The non-transitory computer-readable medium of claim 10, wherein the program instructions that, when executed by the at least one processor, cause the computing platform to generate the respective dynamic link between the submittal data object and each of the one or more schedule-item data objects comprise instructions that, when executed by the at least one processor, cause the computing platform to:
add, to the submittal data object, a respective pointer to each of the one or more schedule-item data objects.

12. The non-transitory computer-readable medium of claim 10, wherein the program instructions that, when executed by the at least one processor, cause the computing platform to generate the respective dynamic link between the submittal data object and each of the one or more schedule-item data objects comprise instructions that, when executed by the at least one processor, cause the computing platform to:
add, to each of the one or more schedule-item data objects, a respective pointer to the submittal data object.

13. The non-transitory computer-readable medium of claim 10, wherein the program instructions that, when executed by the at least one processor, cause the computing platform to generate the respective dynamic link between the submittal data object and each of the one or more schedule-item data objects comprise instructions that, when executed by the at least one processor, cause the computing platform to:
generate, for each of the one or more schedule-item data objects, a respective entry to a link table to represent the respective dynamic link between the submittal data object and the one or more schedule-item data objects.

14. The non-transitory computer-readable medium of claim 10, wherein the non-transitory computer-readable medium is also provisioned with program instructions that, when executed by the at least one processor, cause the computing platform to:
after identifying the one or more schedule-item data objects, cause the client device to display a respective selectable indication for each of the one or more schedule-item data objects; and
receive, from the client device, information indicating a user selection of at least one of the one or more schedule-item data objects to be linked to the submittal data object.

15. The non-transitory computer-readable medium of claim 10, wherein the non-transitory computer-readable medium is also provisioned with program instructions that, when executed by the at least one processor, cause the computing platform to:
before receiving the indication of the change to the due date of the submittal data object, determine, based on the respective start dates of the one or more schedule-item data objects, the due date of the submittal data object; and
update the submittal data object to include the determined due date of the submittal data object.

16. The non-transitory computer-readable medium of claim 10, wherein the non-transitory computer-readable medium is also provisioned with program instructions that, when executed by the at least one processor, cause the computing platform to:
cause the client device to display a respective indication of the determined respective change to the respective start date of each of the one or more schedule-item data objects.

17. The non-transitory computer-readable medium of claim 16, wherein the program instructions that, when executed by the at least one processor, cause the client device to update the respective start date of each of the one or more schedule-item data objects in accordance with the respective change comprise instructions that, when executed by the at least one processor, cause the computing platform to:
cause the client device to display a respective selectable indication of the determined respective change to the respective start date of each of the one or more schedule-item data objects; and
receive, from the client device, information indicating a user confirmation of the respective indication of the determined respective change to the respective start date of at least one of the one or more schedule-item data objects.

18. The non-transitory computer-readable medium of claim 10, wherein the program instructions that, when executed by the at least one processor, cause the computing platform to identify schedule-item data objects related to the submittal data object comprise instructions that, when executed by the at least one processor, cause the computing platform to:
generate a search query that seeks to identify a candidate set of schedule-item data objects that are related to the submittal data object;
perform a search in accordance with the search query to identify the candidate set of schedule-item data objects;
generate a prompt for a generative AI model that comprises a request to determine which of the candidate set of schedule-item data objects are related to the submittal data object;
pass the prompt to the generative AI model;
receive, from the generative AI model, a prediction of which of the candidate set of schedule-item data objects are related to the submittal data object based on the prompt; and
based on the prediction, determine a final set of schedule item data objects that are related to the submittal data object, wherein the final set comprises the one or more schedule-item data objects.

19. A method carried out by a computing platform, the method comprising:
receiving, from a client device, a request to identify schedule-item data objects within a construction management software application that are related to a submittal data object;
based on the request, identifying one or more schedule-item data objects related to the submittal data object;
generating a respective dynamic link between the submittal data object and each of the one or more schedule-item data objects, each schedule-item data object comprising a respective start date;
receiving an indication of a change to a due date of the submittal data object;
determining a respective change to the respective start date of each of the one or more schedule-item data objects based on (i) the respective dynamic link between the submittal data object and the schedule-item data object and (ii) the change to the due date of the submittal data object; and
updating the respective start date of each of the one or more schedule-item data objects in accordance with the respective change.

20. The method of claim 19, further comprising:
after identifying the one or more schedule-item data objects, causing the client device to display a respective selectable indication for each of the one or more schedule-item data objects; and
receiving, from the client device, information indicating a user selection of at least one of the one or more schedule-item data objects to be linked to the submittal data object.
